(19) United States
(12) Patent Application Publication
(10) Pub. No.: US 2023/0098792 A1
(43) Pub. Date: Mar. 30, 2023

(54) VEHICLE DRIVING ASSIST APPARATUS, VEHICLE DRIVING ASSIST METHOD, AND VEHICLE DRIVING ASSIST PROGRAM

(71) Applicant: TOYOTA JIDOSHA KABUSHIKI KAISHA, Toyota-shi (JP)

(72) Inventor: Hideki KAMATANI, Toyota-shi (JP)

(73) Assignee: TOYOTA JIDOSHA KABUSHIKI KAISHA, Toyota-shi (JP)

(21) Appl. No.: 17/946,793

(22) Filed: Sep. 16, 2022

(30) Foreign Application Priority Data
Sep. 24, 2021 (JP) 2021-155683

(51) Int. Cl. B60W 30/16

(52) U.S. Cl. CPC B60W 30/16; B60W 2552/15; B60W 2720/106; B60W 2754/30; B60W 2554/4041

(57) ABSTRACT

A vehicle driving assist apparatus sets a lower limit of an enlarged vehicle moving speed control range such that a first lower limit difference is smaller than a second lower limit difference while an enlarged constant speed moving control is executed. The first lower limit difference is a difference between the lower limit of the enlarged vehicle moving speed control range and a set vehicle moving speed when a constant speed acceleration determination change condition is satisfied. The second lower limit difference is the difference between the lower limit of the enlarged vehicle moving speed control range and the set vehicle moving speed when the constant speed acceleration determination change condition is not satisfied. The constant speed acceleration determination change condition is a condition that the set vehicle moving speed is equal to or smaller than a predetermined vehicle moving speed.

### CROSS-REFERENCE TO RELATED APPLICATIONS

This application claims priority to Japanese patent application No. JP 2021-155683 filed on Sep. 24, 2021, the content of which is hereby incorporated by reference in its entirety.

### BACKGROUND

### Field

The invention relates to a vehicle driving assist apparatus, a vehicle driving assist method, and a vehicle driving assist program.

### Description of the Related Art

There is known a vehicle driving assist apparatus which executes a moving assist control which is a form of autonomous driving to autonomously control an acceleration and a deceleration of an own vehicle to maintain a vehicle moving speed of the own vehicle at a set vehicle moving speed. Further, there is a vehicle driving assist apparatus which improves a fuel economy by (i) decelerating the own vehicle by causing the own vehicle to coast when the own vehicle is required to be decelerated while the moving assist control is executed and (ii) accelerating the own vehicle by operating an internal combustion engine as a driving apparatus of applying a driving force to the own vehicle at a maximum fuel economy operation point when the own vehicle is required to be accelerated while the moving assist control is executed (see JP 2017-193334 A).

When the own vehicle is required to be accelerated or decelerated while the moving assist control is executed, there can be employed a control to (i) set a determination range of a vehicle moving speed having the set vehicle moving speed as a center in order to determine whether the own vehicle is required to be decelerated or accelerated, (ii) decelerate the own vehicle when the vehicle moving speed becomes greater than an upper limit of the determination range, and (iii) accelerate the own vehicle when the vehicle moving speed becomes smaller than a lower limit of the determination range. Thereby, an energy efficient of the driving apparatus can be improved.

In this regard, if the set vehicle moving speed is relatively small, a proportion of a decrease amount of the vehicle moving speed of the own vehicle with respect to the set vehicle moving speed is great. In this case, a driver of the own vehicle may feel that the own vehicle is excessively decelerated. Further, the driving force or the driving torque output from the driving apparatus increases as the vehicle moving speed of the own vehicle decreases. Accordingly, if the set vehicle moving speed is relatively small, and the own vehicle is accelerated by operating the driving apparatus with a maximum energy efficient, the driver may feel that the own vehicle is excessively accelerated.

### SUMMARY

An object of the invention is to provide a vehicle driving assist apparatus, a vehicle driving assist method, and a vehicle driving assist program which executes the moving assist control so as to prevent the driver of the own vehicle from feeling that the own vehicle is excessively decelerated or accelerated and improve the energy efficient of the driving apparatus.

According to the invention, a vehicle driving assist apparatus comprises a driving apparatus and an electronic control unit. The driving apparatus outputs a driving force to be applied to an own vehicle. The electronic control unit executes a constant speed moving control to accelerate and decelerate the own vehicle so as to maintain a vehicle moving speed of the own vehicle at a set vehicle moving speed by controlling operations of the driving apparatus.

The electronic control unit being configured to execute an enlarged constant speed moving control as the constant speed moving control to (a) set an enlarged vehicle moving speed control range which corresponds to a vehicle moving speed range including the set vehicle moving speed and (b) maintain the vehicle moving speed of the own vehicle at the set vehicle moving speed by (i) starting to decelerate the own vehicle when the vehicle moving speed of the own vehicle becomes greater than an upper limit of the enlarged vehicle moving speed control range and (ii) starting to accelerate the own vehicle when the vehicle moving speed of the own vehicle becomes smaller than a lower limit of the enlarged vehicle moving speed control range.

Further, while the enlarged constant speed moving control is executed, the electronic control unit is configured to set the lower limit of the enlarged vehicle moving speed control range such that a first lower limit difference is smaller than a second lower limit difference. The first lower limit difference is a difference between the lower limit of the enlarged vehicle moving speed control range and the set vehicle moving speed while (i) the enlarged constant speed moving control is executed, and (ii) a constant speed acceleration determination change condition is satisfied. The second lower limit difference is the difference between the lower limit of the enlarged vehicle moving speed control range and the set vehicle moving speed while (i) the enlarged constant speed moving control is executed, and (ii) the constant speed acceleration determination change condition is not satisfied. The constant speed acceleration determination change condition is a condition that the set vehicle moving speed is equal to or smaller than a predetermined vehicle moving speed.

Alternatively, while the enlarged constant speed moving control is executed, the electronic control unit is configured to (a) accelerate the own vehicle by operating the driving apparatus with an optimum energy efficient when the own vehicle is required to be accelerated while the constant speed acceleration determination change condition is not satisfied and (b) accelerate the own vehicle by operating the driving apparatus such that the driving force output from the driving apparatus is smaller than the driving force output from the driving apparatus operating with the optimum energy efficient when the own vehicle is required to be accelerated while the constant speed acceleration determination change condition is satisfied.

With the vehicle driving assist apparatus according to the invention, when the set vehicle moving speed is relatively small, the lower limit of the enlarged vehicle moving speed control range is set such that the difference between the lower limit of the enlarged vehicle moving speed control range and the set vehicle moving speed is small. Thereby, while the enlarged constant speed moving control is executed, the own vehicle starts to be accelerated before the vehicle moving speed of the own vehicle becomes considerably small. Thereby, a driver of the own vehicle can be prevented from having an excessive deceleration discomfort or a feeling that the own vehicle is excessively decelerated. In addition, with the vehicle driving assist apparatus according to the invention, when the set vehicle moving speed is relatively small, the own vehicle is accelerated by the driving force which is smaller than the driving force output from the driving apparatus operating with the optimum energy efficient. Thereby, the driver of the own vehicle can be prevented from having an excessive acceleration discomfort or a feeling that the own vehicle is excessively accelerated.

According to an aspect of the invention, the electronic control unit may be configured to execute an ordinary constant speed moving control as the constant speed moving control to (a) set an ordinary vehicle moving speed control range which corresponds to a vehicle moving speed range which includes the set vehicle moving speed and is narrower than the enlarged vehicle moving speed control range and (b) maintain the vehicle moving speed of the own vehicle at the set vehicle moving speed by (i) starting to decelerate the own vehicle when the vehicle moving speed of the own vehicle becomes greater than an upper limit of the ordinary vehicle moving speed control range and (ii) starting to accelerate the own vehicle when the vehicle moving speed of the own vehicle becomes smaller than a lower limit of the ordinary vehicle moving speed control range.

In general, if the constant speed moving control is executed with a broad control range of the vehicle moving speed of the own vehicle, an energy amount which the driving apparatus consumes can be reduced. With the vehicle driving assist apparatus according to this aspect of the invention, a control to be executed can be selected from (i) the enlarged constant speed moving control, based on the enlarged vehicle moving speed control range having the broad control range of the vehicle moving speed of the own vehicle and (ii) the ordinary constant speed moving control, based on the ordinary vehicle moving speed control range having the narrow control range of the vehicle moving speed of the own vehicle. Thereby, when the constant speed moving control is requested to be executed, the energy amount which the driving apparatus consumes can be reduced by selecting and executing the enlarged constant speed moving control as possible.

According to another aspect of the invention, while (i) the enlarged constant speed moving control is executed, and (ii) the constant speed acceleration determination change condition is satisfied, the electronic control unit may be configured to set the lower limit of the enlarged vehicle moving speed control range such that the first lower limit difference is smaller than the second lower limit difference by narrowing the enlarged vehicle moving speed control range.

If the lower limit of the enlarged vehicle moving speed control range is set such that the difference between the lower limit of the enlarged vehicle moving speed control range and the set vehicle moving speed is small, and a width of the enlarged vehicle moving speed control range is maintained constant, an upper limit of the enlarged vehicle moving speed control range is set to a great value. In this case, a center value of the enlarged vehicle moving speed control range is a great value. Thus, if such an enlarged vehicle moving speed control range is used to control the vehicle moving speed of the own vehicle, an average vehicle moving speed of the own vehicle may considerably deviate from the set vehicle moving speed.

With the vehicle driving assist apparatus according to this aspect of the invention, the lower limit of the enlarged vehicle moving speed control range is set such that the difference between the lower limit of the enlarged vehicle moving speed control range and the set vehicle moving speed is small by narrowing the enlarged vehicle moving speed control range. Thereby, when the vehicle moving speed of the own vehicle is controlled by using the enlarged vehicle moving speed control range, the average vehicle moving speed of the own vehicle can be prevented from considerably deviating from the set vehicle moving speed.

According to further another aspect of the invention, the electronic control unit may be configured to set the enlarged vehicle moving speed control range such that the difference between the lower value of the enlarged vehicle moving speed control range and the set vehicle moving speed is greater than a difference between an upper limit value of the enlarged vehicle moving speed control range and the set vehicle moving speed.

With the vehicle driving assist apparatus according to this aspect of the invention, the driver can be prevented from having the excessive deceleration or acceleration discomfort.

According to further another aspect of the invention, the constant speed acceleration determination change condition may include a condition that a gradient of a road on which the own vehicle moves is equal to or smaller than a predetermined upward slope gradient.

When the road on which the own vehicle moves is an even road or a downward slope, the own vehicle can be sufficiently accelerated even by the small driving force. In addition, when the road on which the own vehicle moves is an upward slope having a small upward slope gradient, the own vehicle can be sufficiently accelerated even by the small driving force.

With the vehicle driving assist apparatus according to this aspect of the invention, when (i) the vehicle moving speed of the own vehicle is equal to or smaller than the predetermined vehicle moving speed, and (ii) the gradient of the road on which the own vehicle moves is equal to or smaller than the predetermined upward slope gradient, the driving force applied to the own vehicle for accelerating the own vehicle is controlled to a small driving force. Thus, even when the driving force applied to the own vehicle is controlled to a small driving force, the own vehicle can be sufficiently accelerated.

According to further another aspect of the invention, the electronic control unit may be configured to determine that the constant speed acceleration determination change condition is not satisfied when a gradient of a road on which the own vehicle moves is greater than a predetermined upward slope gradient while (i) the enlarged constant speed moving control is executed, and (ii) the set vehicle moving speed is equal to or smaller than the predetermined vehicle moving speed.

If the driving force for accelerating the own vehicle is decreased when (i) the own vehicle moves on an upward slope, and (ii) the gradient of the upward slope is great, the own vehicle cannot be sufficiently accelerated.

With the vehicle driving assist apparatus according to this aspect of the invention, when (i) the set vehicle moving speed is equal to or smaller than the predetermined vehicle moving speed, and (ii) the gradient of the road on which the own vehicle moves is greater than the predetermined upward slope gradient, the driving force for accelerating the own vehicle is not decreased. Thereby, the own vehicle can be sufficiently accelerated when the own vehicle is required to be accelerated.

According to further another aspect of the invention, when there is a preceding vehicle, in place of the constant speed moving control, the electronic control unit may be configured to (a) execute an enlarged following moving control to (i) start to accelerate the own vehicle when a preceding vehicle separation degree becomes greater than a predetermined preceding vehicle separation degree, which preceding vehicle separation degree being a degree that the own vehicle is separating from the preceding vehicle and (ii) start to decelerate the own vehicle when a preceding vehicle approaching degree becomes greater than a predetermined preceding vehicle approaching degree, which preceding vehicle approaching degree being a degree that the own vehicle is approaching the preceding vehicle, and (b) set the predetermined preceding vehicle separation degree such that the predetermined preceding vehicle separation degree which is set while (i) the enlarged following moving control is executed, and (ii) a following acceleration determination change condition is satisfied, is smaller than the predetermined preceding vehicle separation degree which is set while (i) the enlarged following moving control is executed, and (ii) the following acceleration determination change condition is not satisfied. The following acceleration determination change condition may be a condition that a vehicle moving speed of the preceding vehicle is equal to or smaller than the predetermined vehicle moving speed, or

Alternatively, the electronic control unit may be configured to (a) accelerate the own vehicle by operating the driving apparatus with an optimum energy efficient when the own vehicle is required to be accelerated while (i) the enlarged following moving control is executed, and (ii) the following acceleration determination change condition is not satisfied, and (b) accelerate the own vehicle by operating the driving apparatus so as to output the driving force which is smaller than the driving force output from the driving apparatus operating with the optimum energy efficient when the own vehicle is required to be accelerated while (i) the enlarged following moving control is executed, and (ii) the following acceleration determination change condition is satisfied.

With the vehicle driving assist apparatus according to this aspect of the invention, when the vehicle moving speed of the own vehicle is controlled to a relatively small value by the enlarged following moving control, the own vehicle starts to be accelerated before the own vehicle considerably separates from the preceding vehicle. Thereby, the driver can be prevented from having the excessive deceleration discomfort. Further, with the vehicle driving assist apparatus according to this aspect of the invention, when the vehicle moving speed of the own vehicle is controlled to a relatively small value by the enlarged following moving control, the own vehicle is accelerated by the driving force which is smaller than the driving force output from the driving apparatus operating with the optimum energy efficient. Thereby, the driver can be prevented from having the excessive acceleration discomfort.

A vehicle driving assist method according to the invention is a method of executing a constant speed moving control to accelerate and decelerate an own vehicle so as to maintain a vehicle moving speed of the own vehicle at a set vehicle moving speed by controlling operations of a driving apparatus for outputting a driving force to be applied to the own vehicle.

The vehicle driving assist method comprises executing an enlarged constant speed moving control as the constant speed moving control to (a) set an enlarged vehicle moving speed control range which corresponds to a vehicle moving speed range including the set vehicle moving speed and (b) maintain the vehicle moving speed of the own vehicle at the set vehicle moving speed by (i) starting to decelerate the own vehicle when the vehicle moving speed of the own vehicle becomes greater than an upper limit of the enlarged vehicle moving speed control range and (ii) starting to accelerate the own vehicle when the vehicle moving speed of the own vehicle becomes smaller than a lower limit of the enlarged vehicle moving speed control range.

While the enlarged constant speed moving control is executed, the vehicle driving assist method comprises setting the lower limit of the enlarged vehicle moving speed control range such that a first lower limit difference is smaller than a second lower limit difference while the enlarged constant speed moving control is executed. The first lower limit difference is a difference between the lower limit of the enlarged vehicle moving speed control range and the set vehicle moving speed while (i) the enlarged constant speed moving control is executed, and (ii) a constant speed acceleration determination change condition is satisfied. The second lower limit difference is the difference between the lower limit of the enlarged vehicle moving speed control range and the set vehicle moving speed while (i) the enlarged constant speed moving control is executed, and (ii) the constant speed acceleration determination change condition is not satisfied. The constant speed acceleration determination change condition is a condition that the set vehicle moving speed is equal to or smaller than a predetermined vehicle moving speed.

Alternatively, while the enlarged constant speed moving control is executed, the vehicle driving assist method comprises (a) accelerating the own vehicle by operating the driving apparatus with an optimum energy efficient when the own vehicle is required to be accelerated while the constant speed acceleration determination change condition is not satisfied, and (b) accelerating the own vehicle by operating the driving apparatus such that the driving force output from the driving apparatus is smaller than the driving force output from the driving apparatus operating with the optimum energy efficient when the own vehicle is required to be accelerated while the constant speed acceleration determination change condition is satisfied.

With the vehicle driving assist method according to the invention, when the set vehicle moving speed is relatively small, the lower limit of the enlarged vehicle moving speed control range is set such that the difference between the lower limit of the enlarged vehicle moving speed control range and the set vehicle moving speed is small. Thereby, while the enlarged constant speed moving control is executed, the own vehicle starts to be accelerated before the vehicle moving speed of the own vehicle becomes considerably small. Thereby, the driver of the own vehicle can be prevented from having the excessive deceleration discomfort. In addition, with the vehicle driving assist method according to the invention, when the set vehicle moving speed is relatively small, the own vehicle is accelerated by the driving force which is smaller than the driving force output from the driving apparatus operating with the optimum energy efficient. Thereby, the driver of the own vehicle can be prevented from having the excessive acceleration discomfort or a feeling that the own vehicle is excessively accelerated.

A vehicle driving assist program according to the invention is a program of executing a constant speed moving control to accelerate and decelerate an own vehicle so as to maintain a vehicle moving speed of the own vehicle at a set vehicle moving speed by controlling operations of a driving apparatus for outputting a driving force to be applied to the own vehicle.

The vehicle driving assist program comprises executing an enlarged constant speed moving control as the constant speed moving control to (a) set an enlarged vehicle moving speed control range which corresponds to a vehicle moving speed range including the set vehicle moving speed and (b) maintain the vehicle moving speed of the own vehicle at the set vehicle moving speed by (i) starting to decelerate the own vehicle when the vehicle moving speed of the own vehicle becomes greater than an upper limit of the enlarged vehicle moving speed control range and (ii) starting to accelerate the own vehicle when the vehicle moving speed of the own vehicle becomes smaller than a lower limit of the enlarged vehicle moving speed control range.

While the enlarged constant speed moving control is executed, the vehicle driving assist program comprises setting the lower limit of the enlarged vehicle moving speed control range such that a first lower limit difference is smaller than a second lower limit difference while the enlarged constant speed moving control is executed. The first lower limit difference is a difference between the lower limit of the enlarged vehicle moving speed control range and the set vehicle moving speed while (i) the enlarged constant speed moving control is executed, and (ii) a constant speed acceleration determination change condition is satisfied. The second lower limit difference is the difference between the lower limit of the enlarged vehicle moving speed control range and the set vehicle moving speed while (i) the enlarged constant speed moving control is executed, and (ii) the constant speed acceleration determination change condition is not satisfied. The constant speed acceleration determination change condition is a condition that the set vehicle moving speed is equal to or smaller than a predetermined vehicle moving speed.

Alternatively, while the enlarged constant speed moving control is executed, the vehicle driving assist program comprises (a) accelerating the own vehicle by operating the driving apparatus with an optimum energy efficient when the own vehicle is required to be accelerated while the constant speed acceleration determination change condition is not satisfied and (b) accelerating the own vehicle by operating the driving apparatus such that the driving force output from the driving apparatus is smaller than the driving force output from the driving apparatus operating with the optimum energy efficient when the own vehicle is required to be accelerated while the constant speed acceleration determination change condition is satisfied.

With the vehicle driving assist program according to the invention, when the set vehicle moving speed is relatively small, the lower limit of the enlarged vehicle moving speed control range is set such that the difference between the lower limit of the enlarged vehicle moving speed control range and the set vehicle moving speed is small. Thus, while the enlarged constant speed moving control is executed, the own vehicle starts to be accelerated before the vehicle moving speed of the own vehicle becomes considerably small. Thus, a driver of the own vehicle can be prevented from having the excessive deceleration discomfort or a feeling that the own vehicle is excessively decelerated. In addition, with the vehicle driving assist program according to the invention, when the set vehicle moving speed is relatively small, the own vehicle is accelerated by the driving force which is smaller than the driving force output from the driving apparatus operating with the optimum energy efficient. Thus, the driver of the own vehicle can be prevented from having the excessive acceleration discomfort or a feeling that the own vehicle is excessively accelerated.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle driving assist apparatus according to an embodiment of the invention and a vehicle or an own vehicle on which the vehicle driving assist apparatus is installed.

FIG. 2 is a view which shows a forward inter-vehicle distance and a rearward inter-vehicle distance.

FIG. 3 is a view which shows an energy efficient of an internal combustion engine, an energy efficient of an electric motor, and a required driving force.

FIG. 4 is a view which shows a scene that there is no preceding vehicle nor following vehicle.

FIG. 5 is a view which shows a relationship between a set vehicle moving speed and an enlarged vehicle moving speed lower limit.

FIG. 6A is a view which shows a scene that the forward inter-vehicle distance is greater than a forward middle distance determination value.

FIG. 6B is a view which shows a scene that the forward inter-vehicle distance is equal to or smaller than the forward middle distance determination value.

FIG. 7A is a view which shows a scene that the forward inter-vehicle distance is greater than a forward short distance determination value.

FIG. 7B is a view which shows a scene that the forward inter-vehicle distance is equal to or smaller than the forward short distance determination value.

FIG. 8A is a view which shows a scene that the rearward inter-vehicle distance is greater than a rearward short distance determination value.

FIG. 8B is a view which shows a scene that the rearward inter-vehicle distance is equal to or smaller than the rearward short distance determination value.

FIG. 9 is a view which shows a flowchart of a routine executed by the vehicle driving assist apparatus according to the embodiment of the invention.

FIG. 10 is a view which shows a flowchart of a routine executed by the vehicle driving assist apparatus according to the embodiment of the invention.

FIG. 11 is a view which shows a flowchart of a routine executed by the vehicle driving assist apparatus according to the embodiment of the invention.

FIG. 12 is a view which shows a flowchart of a routine executed by the vehicle driving assist apparatus according to the embodiment of the invention.

FIG. 13 is a view which shows a flowchart of a routine executed by the vehicle driving assist apparatus according to the embodiment of the invention.

FIG. 14 is a view which shows a flowchart of a routine executed by the vehicle driving assist apparatus according to the embodiment of the invention.

FIG. 15 is a view which shows a flowchart of a routine executed by the vehicle driving assist apparatus according to the embodiment of the invention.

FIG. 16 is a view which shows a flowchart of a routine executed by the vehicle driving assist apparatus according to the embodiment of the invention.

FIG. 17 is a view which shows a flowchart of a routine executed by the vehicle driving assist apparatus according to the embodiment of the invention.

FIG. 18 is a view which shows a flowchart of a routine executed by the vehicle driving assist apparatus according to the embodiment of the invention.

FIG. 19 is a view which shows a flowchart of a routine executed by the vehicle driving assist apparatus according to the embodiment of the invention.

### DESCRIPTION OF THE EMBODIMENTS

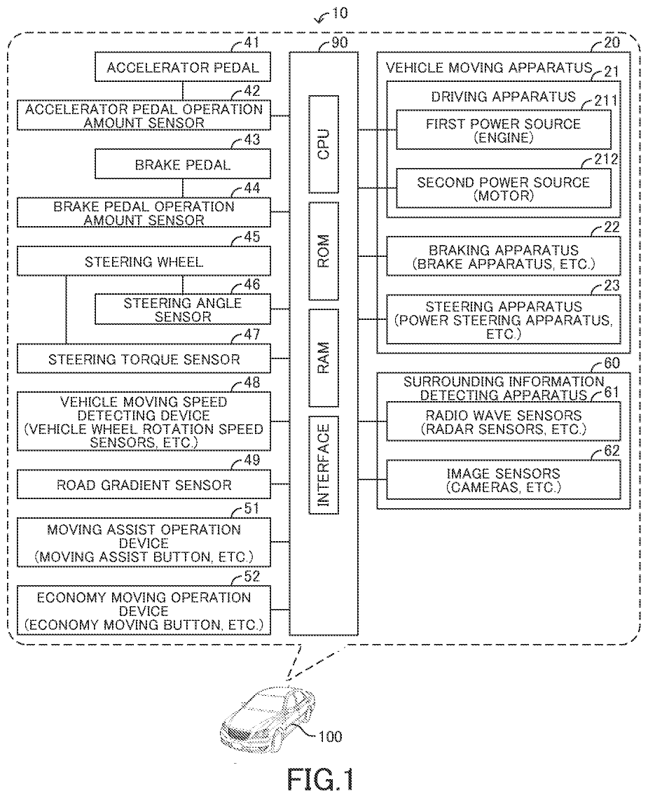

Below, a vehicle driving assist apparatus according to an embodiment of the invention will be described with reference to the drawings. The vehicle driving assist apparatus 10 according to the embodiment of the invention is shown in FIG. 1. The vehicle driving assist apparatus 10 is installed on an own vehicle 100.

The vehicle driving assist apparatus 10 includes an ECU 90. ECU stands for electronic control unit. The ECU 90 includes a micro-computer as a main component. The micro-computer includes a CPU, a ROM, a RAM, a non-volatile memory, and an interface. The CPU is configured or programmed to realize various functions by executing instructions, programs, or routines stored in the ROM.

In particular, the ECU 90 memorizes a program to execute a moving assist control described later in detail in the ROM. In this regard, the ECU 90 may be configured to acquire and memorize such a program wirelessly from devices outside of the own vehicle 100 via a receiving device. In addition, the ECU 90 may be configured to wirelessly update the memorized program by devices outside of the own vehicle 100 via the receiving device.

<Vehicle Moving Apparatus>

A vehicle moving apparatus 20 is installed on the own vehicle 100. The vehicle moving apparatus 20 drives, brakes, and steers the own vehicle 100. In this embodiment, the vehicle moving apparatus 20 includes a driving apparatus 21, a braking apparatus 22, and a steering apparatus 23.

<Driving Apparatus>

The driving apparatus 21 outputs a driving force or a driving torque which is applied to the own vehicle 100 to move the own vehicle 100. In this embodiment, the driving apparatus 21 includes two power sources, i.e., a first power source 211 and a second power source 212 which have different power output properties. The first power source 211 may be an internal combustion chamber, and the second power source 212 may be at least one electric motor. The first power source 211 and the second power source 212 are electrically connected to the ECU 90. The ECU 90 controls the driving force or the driving torque output from the first power source 211 and the second power source 212, respectively by controlling operations of the first power source 211 and the second power source 212, respectively.

<Braking Apparatus>

The braking apparatus 22 outputs a braking force or a braking torque which is applied to the own vehicle 100 to brake the own vehicle 100. The braking apparatus 22 may be a fluidic brake apparatus. The braking apparatus 22 is electrically connected to the ECU 90. The ECU 90 controls the braking force or the braking torque output from the braking apparatus 22 by controlling operations of the braking apparatus 22.

<Steering Apparatus>

The steering apparatus 23 outputs a steering force or a steering torque which is applied to the own vehicle 100 to steer the own vehicle 100. The steering apparatus 23 may be a power steering apparatus. The steering apparatus 23 is electrically connected to the ECU 90. The ECU 90 controls the steering force or the steering torque output from the steering apparatus 23 by controlling operations of the steering apparatus 23.

<Sensors, Etc.>

Further, an accelerator pedal 41, an accelerator pedal operation amount sensor 42, a brake pedal 43, a brake pedal operation amount sensor 44, a steering wheel 45, a steering angle sensor 46, a steering torque sensor 47, a vehicle moving speed detecting device 48, a road gradient sensor 49, a moving assist operation device 51, an economy moving operation device 52, and a surrounding information detecting apparatus 60 are installed on the own vehicle 100.

<Accelerator Pedal Operation Amount Sensor>

The accelerator pedal operation amount sensor 42 detects an operation amount of the accelerator pedal 41. The accelerator pedal operation amount sensor 42 is electrically connected to the ECU 90. The accelerator pedal operation amount sensor 42 sends information on the detected operation amount to the ECU 90. The ECU 90 acquires the operation amount of the accelerator pedal 41 as an accelerator pedal operation amount AP, based on the information sent from the accelerator pedal operation amount sensor 42.

The ECU 90 calculates and acquires a required driving force PD_REQ or a required driving torque, based on the accelerator pedal operation amount AP and a moving speed of the own vehicle 100 or an own vehicle moving speed while the ECU 90 does not execute the moving assist control described later in detail. The ECU 90 controls the operations of the driving apparatus 21 so as to output the driving force or the driving torque corresponding to the required driving force PD_REQ or the required driving torque from the driving apparatus 21. On the other hand, while the ECU 90 executes the moving assist control described later in detail, the ECU 90 determines the driving force or the driving torque necessary to move the own vehicle 100 in a desired manner by the moving assist control and controls the operations of the driving apparatus 21 so as to output the driving force or the driving torque corresponding to the determined driving force or the determined driving torque from the driving apparatus 21.

<Brake Pedal Operation Amount Sensor>

The brake pedal operation amount sensor 44 detects an operation amount of the brake pedal 43. The brake pedal operation amount sensor 44 is electrically connected to the ECU 90. The brake pedal operation amount sensor 44 sends information on the detected operation amount to the ECU 90. The ECU 90 acquires the operation amount of the brake pedal 43 as a brake pedal operation amount BP, based on the information sent from the brake pedal operation amount sensor 44.

The ECU 90 calculates and acquires a required braking force PB_REQ or a required braking torque, based on the brake pedal operation amount BP while the ECU 90 does not execute the moving assist control described later in detail. The ECU 90 controls the operations of the braking apparatus 22 so as to output the braking force or the braking torque corresponding to the required braking force PB_REQ or the required braking torque from the braking apparatus 22. On the other hand, while the ECU 90 executes the moving assist control described later in detail, the ECU 90 determines the braking force or the braking torque necessary to move the own vehicle 100 in a desired manner by the moving assist control and controls the operations of the braking apparatus 22 so as to output the braking force or the braking torque corresponding to the determined braking force or the determined braking torque from the braking apparatus 22.

<Steering Angle Sensor>

The steering angle sensor 46 detects a rotation angle of the steering wheel 45 with respect to a neutral position thereof. The steering angle sensor 46 is electrically connected to the ECU 90. The steering angle sensor 46 sends information on the detected rotation angle of the steering wheel 45 to the ECU 90. The ECU 90 acquires the rotation angle of the steering wheel 45 as a steering angle 0, based on the information sent from the steering angle sensor 46.

<Steering Torque Sensor>

The steering torque sensor 47 detects a torque which a driver D of the own vehicle 100 inputs to a steering shaft via the steering wheel 45. The steering torque sensor 47 is electrically connected to the ECU 90. The steering torque sensor 47 sends information on the detected torque to the ECU 90. The ECU 90 acquires the torque which the driver D inputs to the steering shaft via the steering wheel 45 as a driver input steering torque, based on the information sent from the steering torque sensor 47.

The ECU 90 acquires a required steering force or a required steering torque, based on the steering angle q, the driver input steering torque, and the moving speed of the own vehicle 100 or the own vehicle moving speed and controls the operations of the steering apparatus 23 so as to output the steering force or the braking torque corresponding to the required steering force or the required steering torque from the steering apparatus 23.

<Vehicle Moving Speed Detecting Device>

The vehicle moving speed detecting device 48 detects the moving speed of the own vehicle 100. The vehicle moving speed detecting device 48 may include vehicle wheel rotation speed sensors. The vehicle moving speed detecting device 48 is electrically connected to the ECU 90. The vehicle moving speed detecting device 48 sends information on the detected moving speed of the own vehicle 100 to the ECU 90. The ECU 90 acquires the moving speed of the own vehicle 100 as the own vehicle moving speed VO, based on the information sent from the vehicle moving speed detecting device 48.

<Road Gradient Sensor>

The road gradient sensor 49 detects a gradient of a road on which the own vehicle 100 moves. The road gradient sensor 49 may be a longitudinal acceleration sensor or a gyroscope sensor. The road gradient sensor 49 is electrically connected to the ECU 90. The road gradient sensor 49 sends information on the detected gradient of the road to the ECU 90. The ECU 90 acquires the gradient RA of the road on which the own vehicle 100 moves, based on the information sent from the road gradient sensor 49.

<Moving Assist Operation Device>

The moving assist operation device 51 is a device operated by the driver D of the own vehicle 100. The moving assist operation device 51 may include switches and/or buttons. The switches and/or the buttons may be provided on the steering wheel 45 and/or a lever pivotably provided on a steering column of the own vehicle 100.

In this embodiment, the moving assist operation device 51 include a moving assist selecting switch, a vehicle moving speed setting switch, a vehicle moving speed increasing button, a vehicle moving speed decreasing button, and an inter-vehicle distance setting button. The moving assist operation device 51 is electrically connected to the ECU 90.

When the moving assist selecting switch is operated by the driver D while the moving assist control described later in detail is not executed, a predetermined signal is sent to the ECU 90 from the moving assist operation device 51. When the ECU 90 receives the signal in question, the ECU 90 determines that the moving assist control is requested to be executed. On the other hand, when the moving assist selecting switch is operated by the driver D while the moving assist control is executed, a predetermined signal is sent to the ECU 90 from the moving assist operation device 51. When the ECU 90 receives the signal in question, the ECU 90 determines that the moving assist control is not requested to be executed. In other words, the ECU 90 determines that the moving assist control is requested to be terminated.

When the vehicle moving speed setting switch is operated by the driver D while the moving assist control is executed, a predetermined signal is sent to the ECU 90 from the moving assist operation device 51. When the ECU 90 receives the signal in question, the ECU 90 sets the current own vehicle moving speed VO or the current moving speed of the own vehicle 100 as a set vehicle moving speed V_SET used in the moving assist control.

Further, when the vehicle moving speed increasing button is operated by the driver D while the moving assist control is executed, a predetermined signal is sent to the ECU 90 from the moving assist operation device 51. When the ECU 90 receives the signal in question, the ECU 90 increases the set vehicle moving speed V_SET. On the other hand, when the vehicle moving speed decreasing button is operated by the driver D while the moving assist control is executed, a predetermined signal is sent to the ECU 90 from the moving assist operation device 51. When the ECU 90 receives the signal in question, the ECU 90 decreases the set vehicle moving speed V_SET.

Furthermore, when the inter-vehicle distance setting button is operated by the driver D while the moving assist control is executed, a predetermined signal is sent to the ECU 90 from the moving assist operation device 51. The signal in question is a requested inter-vehicle distance signal which represents a requested forward inter-vehicle distance DF_REQ which the driver D requests as a forward inter-vehicle distance DF used in a following moving control of the moving assist control by operating the inter-vehicle distance setting button. The forward inter-vehicle distance DF is a distance between the own vehicle 100 and a preceding vehicle 200F.

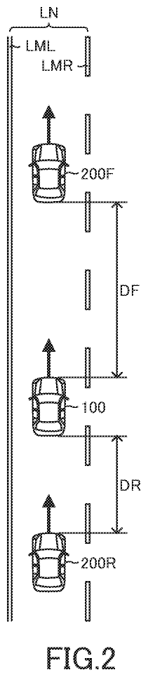

As shown in FIG. 2, the forward inter-vehicle distance DF is a distance between the own vehicle 100 and the preceding vehicle 200F. The forward inter-vehicle distance DF is acquired, based on surrounding detection information IS described later in detail. In this embodiment, the preceding vehicle 200F is a vehicle which moves in an own vehicle moving lane LN in front of the own vehicle 100 and has the forward inter-vehicle distance DF which is equal to or smaller than a predetermined distance or a preceding vehicle determination distance DF_TH. The own vehicle moving lane LN is a traffic lane in which the own vehicle 100 moves. The own vehicle moving lane LN is recognized, based on information on a lane marking LML at the left side of the own vehicle 100 and a lane marking LMR at the right side of the own vehicle 100. The lane markings LML and LMR are acquired, based on the surrounding detection information IS described later in detail. In this embodiment, the requested forward inter-vehicle distance DF_REQ can be to one of three distances, i.e. a long distance, a middle distance, and a short distance by the driver D operating the inter-vehicle distance setting button.

In this embodiment, when the ECU 90 receives the requested inter-vehicle distance signal, the ECU 90 sets the set forward inter-vehicle distance DF_SET, based on the current own vehicle moving speed VO and the requested forward inter-vehicle distance DF_REQ. In this regard, the ECU 90 may be configured to set the requested forward inter-vehicle distance DF_REQ as the set forward inter-vehicle distance DF_SET without considering the current own vehicle moving speed VO when the ECU 90 receives the requested inter-vehicle distance signal.

In particular, the ECU 90 sets the set forward inter-vehicle distance DF_SET to the forward inter-vehicle distance DF which makes a predicted reaching time TTC correspond to a predetermined time or a predetermined predicted reaching time TTC_REF. The predicted reaching time TTC is a time acquired by dividing the forward inter-vehicle distance DF by the current own vehicle moving speed VO. In other words, the ECU 90 sets the set forward inter-vehicle distance DF SET to the forward inter-vehicle distance DF which makes a relationship between the current own vehicle moving speed VO, the predetermined predicted reaching time TTC_REF, and the forward inter-vehicle distance DF correspond to a relationship defined by an expression 1 below.

TTC_REF=DF/VO (1)

The predetermine predicted reaching time TTC_REF is a long time TTC_L when the requested forward inter-vehicle distance DF_REQ is the long distance. When the requested forward inter-vehicle distance DF_REQ is the middle distance, the predetermined predicted reaching time TTC_REF is a middle time TTC_M. When the requested forward inter-vehicle distance DF_REQ is the short distance, the predetermined predicted reaching time TTC_REF is a short time TTC_S.

It should be noted that the preceding vehicle determination distance DF_TH is greater than the set forward inter-vehicle distance DF_SET.

<Economy Moving Operation Device>

The economy moving operation device 52 is a device operated by the driver D of the own vehicle 100. The economy moving operation device 52 may include switches and buttons. The switches and the buttons may be provided on the steering wheel 45 or the lever pivotably provided on the steering column of the own vehicle 100.

When the economy moving operation device 52 in an OFF position is operated, the economy moving operation device 52 is set in an ON position. When the economy moving operation device 52 is set in the ON position, the economy moving operation device 52 sends a predetermined signal to the ECU 90. When the ECU 90 receives the signal in question, the ECU 90 determines that the driver D requests to execute an enlarged constant speed moving control or an economy constant speed moving control described later in detail. When the ECU 90 determines that the driver D requests to execute the enlarged constant speed moving control or the economy constant speed moving control, the ECU 90 determines that an economy moving condition is satisfied.

On the other hand, when the economy moving operation device 52 in the ON position is operated, the economy moving operation device 52 is set in the OFF position. When the economy moving operation device 52 is set in the OFF position, the economy moving operation device 52 sends a predetermined signal to the ECU 90. When the ECU 90 receives the signal in question, the ECU 90 determines that the driver D does not request to execute the economy constant speed moving control or the enlarged constant speed moving control. When the ECU 90 determines that the driver D does not request to execute the economy constant speed moving control or the enlarged constant speed moving control, the ECU 90 determines that the economy moving condition is not satisfied.

<Surrounding Information Detecting Apparatus>

The surrounding information detecting apparatus 60 detects information around the own vehicle 100. In this embodiment, the surrounding information detecting apparatus 60 includes radio wave sensors 61 and image sensors 62.

<Radio Wave Sensors>

The radio wave sensor 61 detects information on objects around the own vehicle 100 by using radio waves. The radio wave sensor 61 may be a radar sensor such as a millimeter wave radar, a sonic wave sensor such as an ultrasonic wave sensor such as a clearance sensor, or an optical sensor such as a laser radar such as a LiDAR. The radio wave sensors 61 are electrically connected to the ECU 90. The radio wave sensor 61 transmits the radio waves and receives the radio waves reflected on the objects or reflected waves. The radio wave sensor 61 sends information on the transmitted radio waves and the received radio waves or the received reflected waves. In other words, the radio wave sensor 61 detects the objects around the own vehicle 100 and send information on the detected objects to the ECU 90. The ECU 90 acquires information or surrounding detection information IS on the objects around the own vehicle 100, based on the information sent from the radio wave sensor 61 or radio wave information IR or radio wave date. The objects detected by the radio wave sensors 61 may be vehicles, walls, bicycles, and persons.

<Image Sensors>

The image sensor 62 takes images of a view around the own vehicle 100. The image sensor 62 may be a camera. The image sensors 62 are electrically connected to the ECU 90. The image sensor 62 takes images of a view around the own vehicle 100 and sends information on the taken images to the ECU 90. The ECU 90 acquires the surrounding detection information IS on the view around the own vehicle 100, based on the information sent from the image sensors 62 or image information IC or image data.

The ECU 90 acquires a distance between the preceding vehicle 200F and the own vehicle 100 as the forward inter-vehicle distance DF, based on the surrounding detection information IS. In addition, the ECU 90 acquires a moving speed of the preceding vehicle 200F as a preceding vehicle moving speed VF, based on the surrounding detection information IS. Further, the ECU 90 acquires a distance between a following vehicle 200R and the own vehicle 100 as a rearward inter-vehicle distance DR, based on the surrounding detection information IS. In addition, the ECU 90 acquires a moving speed of the following vehicle 200R as a following vehicle moving speed VR, based on the surrounding detection information IS.

As shown in FIG. 2, the rearward inter-vehicle distance DR is a distance between the own vehicle 100 and the following vehicle 200R. In this embodiment, the following vehicle 200R is a vehicle which moves in the lane on which the own vehicle 100 moves or the own vehicle moving lane LN behind the own vehicle 100 and has a distance from the own vehicle 100 (i.e., the rearward inter-vehicle distance DR) which is equal to or smaller than a following vehicle determination distance DR_TH.

<Summary of Operations of Vehicle Driving Assist Apparatus>

Next, a summary of operations of the vehicle driving assist apparatus 10 will be described. The vehicle driving assist apparatus 10 is configured to execute a moving assist control to move the own vehicle 100 by autonomously controlling an acceleration and a deceleration of the own vehicle 100 so as to satisfy a predetermined condition, independently of operations applied to the accelerator pedal 41 and the brake pedal 43 by the driver D.

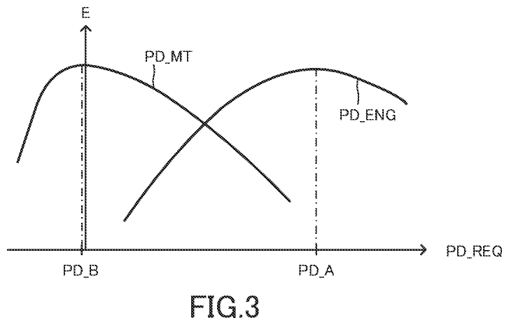

As described above, the driving apparatus 21 includes the first power source 211 and the second power source 212. The first power source 211 and the second power source 212 have different power output properties. In this embodiment, the first power source 211 and the second power source 212 have the power output properties shown in FIG. 3. In particular, an energy efficient with which the first power source 211 (for example, the internal combustion engine) outputs the driving force (or an energy efficient El of the first power source 211) is greatest when the driving force output from the first power source 211 is a specific value PD_A as shown by a line PD_ENG. Further, as shown by a line PD_MT, an energy efficient with which the second power source 212 (for example, the electric motor) outputs the driving force (or an energy efficient E2 of the second power source 212) is greatest when the driving force output from the second power source 212 is a specific value PD_B which is smaller than the specific value PD_A.

It should be noted that when the first power source 211 is the internal combustion engine, the energy efficient El of the first power source 211 is a so-called fuel efficiency, and when the second power source 212 is the electric motor, the energy efficient E2 of the second power source 212 is a so-called power efficiency.

As understood, the energy efficient with which the driving apparatus 21 outputs the driving force (or an energy efficient E of the driving apparatus 21) has a property that the energy efficient E takes peaks (in this embodiment, two peaks) when the driving apparatus 21 outputs the driving force corresponding to a particular value or an optimum driving force PD_OPT. Thus, the energy efficient E of the driving apparatus 21 can be improved by accelerating the own vehicle 100 by the driving apparatus 21 outputting the driving force corresponding to the optimum driving force PD_OPT.

Accordingly, when the own vehicle 100 is tolerated to be accelerated and decelerated with the energy efficient E of the driving apparatus 21 being maintained great, the vehicle driving assist apparatus 10 executes a coasting deceleration control as a control to decelerate the own vehicle 100 and an optimum acceleration control as a control to accelerate the own vehicle 100.

In this embodiment, the coasting deceleration control is a control to decelerate the own vehicle 100 by causing the own vehicle to coast by controlling the operations of the driving apparatus 21 so as to render the driving force output from the driving apparatus 21 zero. It should be noted that when the driving apparatus 21 includes the electric motor, the coasting deceleration control may be a control to decelerate the own vehicle 100 by causing the own vehicle 100 to coast by controlling the operations of the driving apparatus 21 so as to render the driving force output from the driving apparatus 21 zero and regenerating electric power by rotating the electric motor by movement or moving energy of the own vehicle 100.

Further, in this embodiment, the optimum acceleration control is a control to (i) calculate a required acceleration G_REQ which corresponds to an optimum acceleration G_OPT, i.e., the acceleration of the own vehicle 100 which leads to the greatest energy efficient E of the driving apparatus 21 outputting the driving force at the current own vehicle moving speed VO, (ii) calculate the required driving force PD_REQ which corresponds to the driving force realizing the acceleration corresponding to the required acceleration G_REQ, and (iii) accelerate the own vehicle 100 by controlling the operations of the driving apparatus 21 so as to output the driving force corresponding to the required driving force PD_REQ.

It should be noted that the optimum acceleration control may be a control to (i) calculate the required acceleration G_REQ which corresponds to an acceleration which is greater or slightly smaller than the optimum acceleration G_OPT, (ii) calculate the required driving force PD_REQ which corresponds to the driving force realizing the acceleration corresponding to the required acceleration G_REQ, and (iii) accelerate the own vehicle 100 by controlling the operations of the driving apparatus 21 so as to output the driving force corresponding to the required driving force PD_REQ. In other words, the optimum acceleration control may be a control to operate the driving apparatus 21 with the optimum energy efficient which includes (i) a maximum energy efficient and (ii) an energy efficient which is slightly smaller than the maximum energy efficient.

Further, in this embodiment, in general, the vehicle driving assist apparatus 10 is configured to execute two control, i.e., (i) an ordinary moving assist control and (ii) an enlarged moving assist control or an economy moving assist control as the moving assist control. In particular, the vehicle driving assist apparatus 10 is configured to execute (i) an ordinary constant speed moving control and (ii) an ordinary following moving control as the ordinary moving assist control and execute (i) an enlarged constant speed moving control and (ii) an enlarged following moving control as the enlarged moving assist control.

<Ordinary Moving Assist Control>

When (i) a moving assist execution condition becomes satisfied, and (ii) the economy moving condition is not satisfied, the vehicle driving assist apparatus 10 starts to execute the ordinary moving assist control.

In this embodiment, the vehicle driving assist apparatus 10 determines that the moving assist execution condition becomes satisfied when (i) the vehicle driving assist apparatus 10 determines that the driver D requests to execute the moving assist control, and (ii) neither the accelerator pedal 41 nor the brake pedal 43 are operated by the driver D. In this regard, the vehicle driving assist apparatus 10 may be configured to determine that the moving assist execution condition becomes satisfied when the vehicle driving assist apparatus 10 determines that the driver D requests to execute the moving assist control, independently of whether the accelerator pedal 41 or the brake pedal 43 is operated by the driver D.

Further, when the vehicle driving assist apparatus 10 determines that the driver D requests to terminate executing the moving assist control while the vehicle driving assist apparatus 10 executes the moving assist control, the vehicle driving assist apparatus 10 determines that the moving assist execution condition becomes unsatisfied, that is, a moving assist control termination condition (i.e., a condition for terminating executing the moving assist control) becomes satisfied. In addition, when the accelerator pedal 41 or the brake pedal 43 is operated by the driver D while the vehicle driving assist apparatus 10 executes the moving assist control, the vehicle driving assist apparatus 10 also determines that the moving assist execution condition becomes unsatisfied.

When there is a preceding vehicle 200F, the vehicle driving assist apparatus 10 executes the ordinary following moving control as the ordinary moving assist control. It should be noted that when there is a vehicle which moves in the own vehicle moving lane LN ahead of the own vehicle 100 and has the forward inter-vehicle distance DF which is equal to or smaller than the preceding vehicle determination distance DF_TH, the vehicle driving assist apparatus 10 determines that there is a preceding vehicle 200F.

On the other hand, when there is no preceding vehicle 200F, the vehicle driving assist apparatus 10 executes the ordinary constant speed moving control as the ordinary moving assist control.

<Ordinary Following Moving Control>

While the vehicle driving assist apparatus 10 executes the ordinary following moving control, the vehicle driving assist apparatus 10 accelerates and decelerates the own vehicle 100 so as to maintain the forward inter-vehicle distance DF at the set forward inter-vehicle distance DF _SET. In this embodiment, while the vehicle driving assist apparatus 10 executes the ordinary following moving control, the vehicle driving assist apparatus 10 accelerates and decelerates the own vehicle 100 so as to maintain the predicted reaching time TTC at the predetermined predicted reaching time TTC_REF.

In particular, while the vehicle driving assist apparatus 10 executes the ordinary following moving control, the vehicle driving assist apparatus 10 calculates the required acceleration G_REQ which corresponds to the acceleration G of the own vehicle 100 necessary to control the predicted reaching time TTC to the predetermined predicted reaching time TTC_REF. In this case, the vehicle driving assist apparatus 10 calculates the required acceleration G_REQ which realizes a convergence speed (i.e., a speed of the predicted reaching time TTC converging to the predetermined predicted reaching time TTC_REF) which is equal to or greater than a predetermined speed.

After the vehicle driving assist apparatus 10 calculates the required acceleration G_REQ, the vehicle driving assist apparatus 10 calculates the required driving force PD_REQ or the required braking force PB_REQ which realizes the acceleration corresponding the required acceleration G_REQ, and controls the operations of the driving apparatus 21 and/or the braking apparatus 22 so as to output the driving force corresponding to the required driving force PD_REQ or the braking force corresponding to the required braking force PB_REQ. Thereby, when the predicted reaching time TTC becomes greater than the predetermined predicted reaching time TTC_REF, the vehicle driving assist apparatus 10 starts to accelerate the own vehicle 100 and on the other hand, when the predicted reaching time TTC becomes smaller than the predetermined predicted reaching time TTC_REF, the vehicle driving assist apparatus 10 starts to decelerate the own vehicle 100.

<Ordinary Constant Speed Moving Control>

On the other hand, while the vehicle driving assist apparatus 10 executes the ordinary constant speed moving control, the vehicle driving assist apparatus 10 accelerates and decelerates the own vehicle 100 so as to maintain the own vehicle moving speed VO at the set vehicle moving speed V_SET. In this embodiment, while the vehicle driving assist apparatus 10 executes the ordinary constant speed moving control, the vehicle driving assist apparatus 10 calculates the required acceleration G_REQ which corresponds to the acceleration G of the own vehicle 100 necessary to control the own vehicle moving speed VO to the set vehicle moving speed V_SET. In this case, the vehicle driving assist apparatus 10 calculates the required acceleration G_REQ which realizes a convergence speed (i.e., a speed of the own vehicle moving speed VO converging to the set vehicle moving speed V_SET) which is equal to or greater than a predetermined speed.

After the vehicle driving assist apparatus 10 calculates the required acceleration G_REQ, the vehicle driving assist apparatus 10 calculates the required driving force PD_REQ or the required braking force PB_REQ which realizes the acceleration corresponding the required acceleration G_REQ, and controls the operations of the driving apparatus 21 and/or the braking apparatus 22 so as to output the driving force corresponding to the required driving force PD_REQ or the braking force corresponding to the required braking force PB_REQ. Thereby, when the own vehicle moving speed VO becomes smaller than the set vehicle moving speed V_SET, the vehicle driving assist apparatus 10 starts to accelerate the own vehicle 100 and on the other hand, when the own vehicle moving speed VO becomes greater than the set vehicle moving speed V_SET, the vehicle driving assist apparatus 10 starts to decelerate the own vehicle 100.

It should be noted that in this embodiment, the vehicle driving assist apparatus 10 accelerates and decelerates the own vehicle 100 by using the set vehicle moving speed V_SET as a reference while the vehicle driving assist apparatus 10 executes the ordinary constant speed moving control. In this regard, the vehicle driving assist apparatus 10 may be configured to (i) set an ordinary vehicle moving speed control range R_N (i.e., a vehicle moving speed range including the set vehicle moving speed V_SET) as a reference for determining whether to accelerate or decelerate the own vehicle 100, depending on the set vehicle moving speed V_SET, (ii) start to accelerate the own vehicle 100 to increase the own vehicle moving speed VO when the own vehicle moving speed VO becomes smaller than an ordinary vehicle moving speed lower limit VL_N (i.e., a lower limit of the ordinary vehicle moving speed control range R_N), and (iii) start to decelerate the own vehicle 100 to decrease the own vehicle moving speed VO when the own vehicle moving speed VO becomes greater than an ordinary vehicle moving speed upper limit VU_N (i.e., an upper limit of the ordinary vehicle moving speed control range R_N). Thereby, an average VO_AV of the own vehicle moving speed VO is controlled to around the set vehicle moving speed V_SET.

<Enlarged Moving Assist Control (Economy Moving Assist Control)>

On the other hand, when the moving assist execution condition becomes satisfied, and the economy moving condition is satisfied, the vehicle driving assist apparatus 10 starts to execute the enlarged moving assist control or the economy moving assist control. In this case, the vehicle driving assist apparatus 10 executes the economy moving assist control, depending on whether there is a preceding vehicle 200F or a following vehicle 200R.

<Enlarged Constant Speed Moving Control (Economy Constant Speed Moving Control>

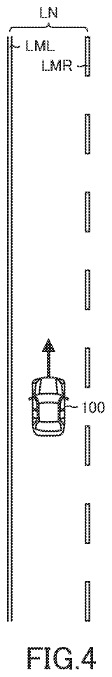

When there is neither preceding vehicle 200F nor following vehicle 200R as shown in FIG. 4, the vehicle driving assist apparatus 10 executes the enlarged constant speed moving control or the economy constant speed moving control as the enlarged moving assist control.

While the vehicle driving assist apparatus 10 executes the enlarged constant speed moving control, the vehicle driving assist apparatus 10 sets an enlarged vehicle moving speed control range R_E (i.e., a vehicle moving speed range including the set vehicle moving speed V_SET) as the reference for determining whether to accelerate or decelerate the own vehicle 100, depending on the set vehicle moving speed V_SET.

In this embodiment, the enlarged vehicle moving speed control range R_E is set to a range which includes the set vehicle moving speed V_SET and is broader than the ordinary vehicle moving speed control range R_N.

Further, when the ordinary vehicle moving speed control range R_N is set, an enlarged vehicle moving speed upper limit VU_E (i.e., an upper limit of the enlarged vehicle moving speed control range R_E) is set to a value which is greater than the ordinary vehicle moving speed lower limit VU_N (i.e., the upper limit of the ordinary vehicle moving speed control range R_N) on condition that the set vehicle moving speed V_SET is the same, and an enlarged vehicle moving speed lower limit VL_E (i.e., a lower limit of the enlarged vehicle moving speed control range R_E) is set to a value which is smaller than the ordinary vehicle moving speed lower limit VL_N (i.e., the lower value of the ordinary vehicle moving speed control range R_N) on condition that the set vehicle moving speed V_SET is the same. It should be noted that the enlarged vehicle moving speed upper limit VU_E is set to a value which is not greater than a speed limit which regulates the own vehicle 100.

Further, the enlarged vehicle moving speed control range R_E is set such that a difference between the set vehicle moving speed V_SET and the enlarged vehicle moving speed lower limit VL_E (i.e., the lower limit of the enlarged vehicle moving speed control range R_E) is greater than a difference between the set vehicle moving speed V_SET and the enlarged vehicle moving speed upper limit VU_E (the upper limit of the enlarged vehicle moving speed control range R_E).

After the vehicle driving assist apparatus 10 sets the enlarged vehicle moving speed control range R_E, the vehicle driving assist apparatus 10 starts to execute an acceleration control when the own vehicle moving speed VO becomes smaller than the enlarged vehicle moving speed lower limit VL_E. On the other hand, the vehicle driving assist apparatus 10 starts to execute a coasting deceleration control when the own vehicle moving speed VO becomes greater than the enlarged vehicle moving speed upper limit VU_E. Thereby, the average VO_AV of the own vehicle moving speed VO is controlled to around the set vehicle moving speed V_SET. In other words, the vehicle driving assist apparatus 10 accelerates and decelerates the own vehicle 100 so as to maintain the own vehicle moving speed VO at the set vehicle moving speed V_SET.

Further, in this embodiment, the acceleration control is a control to accelerate the own vehicle 100 by increasing the driving force applied to the own vehicle 100 from the driving apparatus 21.

If the enlarged vehicle moving speed lower limit VL_E is set to a value which is calculated by subtracting a constant value from the set vehicle moving speed V_SET, a proportion of the constant value to the small set vehicle moving speed V_SET is greater than the proportion of the constant value to the great set vehicle moving speed V_SET. Thus, in case that the set vehicle moving speed V_SET is set to a small vehicle moving speed, the own vehicle 100 starts to be accelerated when the vehicle moving speed of the own vehicle 100 decreases by a value which occupies the great proportion to the set vehicle moving speed V_SET. Thus, the driver D of the own vehicle 100 may have an excessive deceleration discomfort (i.e., a discomfort that the own vehicle 100 is excessively decelerated).

In other words, the enlarged moving assist control is for increasing the energy efficient E of the driving apparatus 21 by executing the coasting deceleration control for a long time as possible, but if the acceleration control (i.e., the control to accelerate the own vehicle 100) starts to be executed at a delayed time in case that the own vehicle moving speed VO is controlled within a low speed range, the driver D may have the excessive deceleration discomfort.

Accordingly, the vehicle driving assist apparatus 10 appropriately changes acceleration start determination parameters or parameters for determining a start timing of the acceleration control (i.e., the control to accelerate the own vehicle 100) in case that the own vehicle moving speed VO is controlled within the low speed range while the enlarged moving assist control is executed.

In particular, while (i) the enlarged constant speed moving control is executed, and (ii) the set vehicle moving speed V_SET is equal to or smaller than a predetermined vehicle moving speed V_TH (i.e., a constant speed acceleration determination change condition is satisfied), the vehicle driving assist apparatus 10 sets the enlarged vehicle moving speed lower limit VL_E to a value which realizes a smaller difference between the enlarged vehicle moving speed lower limit VL_E and the set vehicle moving speed V_SET than the difference between the enlarged vehicle moving speed lower limit VL_E and the set vehicle moving speed V_SET realized while (i) the enlarged constant speed moving control is executed, and (ii) the set vehicle moving speed V_SET is greater than the predetermined vehicle moving speed V_TH (i.e., the constant speed acceleration determination change condition is not satisfied).

In particular, when the set vehicle moving speed V_SET is greater than the predetermined vehicle moving speed V_TH, the vehicle driving assist apparatus 10 sets the enlarged vehicle moving speed lower limit VL_E to a standard lower limit VL_E_S (i.e., the vehicle moving speed which is smaller than the set vehicle moving speed V_SET by a predetermined value or a standard value V_S) (VL_E=V_SET−V_S). On the other hand, when the set vehicle moving speed V_SET is equal to or smaller than the predetermined vehicle moving speed V_TH, the vehicle driving assist apparatus 10 sets the enlarged vehicle moving speed lower limit VL_E to the vehicle moving speed which is smaller than the set vehicle moving speed V_SET by a small value or a decreased value V_L which is smaller than the standard value V_S (VL_E=V_SET−V_L).

Thereby, when the set vehicle moving speed V_SET is set to a small vehicle moving speed and as a result, the own vehicle moving speed VO is a small speed while the enlarged constant speed moving control is executed, the own vehicle 100 starts to be accelerated before the own vehicle moving speed VO considerably decreases with respect to the set vehicle moving speed V_SET. Thereby, the driver D can be prevented from having the excessive deceleration discomfort.

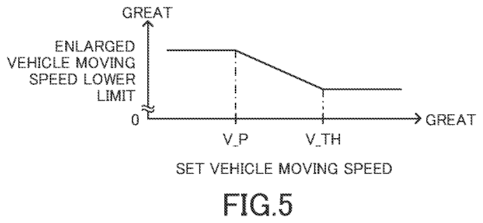

It should be noted that the vehicle driving assist apparatus 10 may be configured to set the enlarged vehicle moving speed lower limit VL_E, depending on the set vehicle moving speed V_SET when the constant speed acceleration determination change condition becomes satisfied. In this case, as shown in FIG. 5, the vehicle driving assist apparatus 10 may be configured to set the enlarged vehicle moving speed lower limit VL_E to a value which increases as the set vehicle moving speed V_SET decreases in case that the set vehicle moving speed V_SET is between the predetermined vehicle moving speed V_TH and a certain vehicle moving speed V_P. Also, the vehicle driving assist apparatus 10 may be configured to set the enlarged vehicle moving speed lower limit VL_E to the same value as the enlarged vehicle moving speed lower limit VL_E which is set when the set vehicle moving speed V_SET is the certain vehicle moving speed V_P in case that the set vehicle moving speed V_SET is smaller than the certain vehicle moving speed V_P.

Further, when the set vehicle moving speed V_SET is set to a small vehicle moving speed, the average VO_AVE of the own vehicle moving speed VO is small. In this case, if the optimum acceleration control starts to be executed when the own vehicle moving speed VO becomes smaller than the enlarged vehicle moving speed lower limit VL_E, the driver D may have an excessive acceleration discomfort (i.e., a discomfort that the own vehicle 100 is excessively accelerated).

As described above, the enlarged moving assist control is for increasing the energy efficient E of the driving apparatus 21 by executing the coasting deceleration control for a long time as possible, but if the own vehicle 100 is accelerated by the optimum acceleration control in case that the own vehicle moving speed VO is controlled within a low speed range, the driver D may have the excessive acceleration discomfort.

Accordingly, the vehicle driving assist apparatus 10 appropriately changes the driving force applied to the own vehicle 100 for accelerating the own vehicle 100 in case that the own vehicle moving speed VO is controlled within a low speed range while the enlarged moving assist control is executed.

In particular, while (i) the enlarged constant speed moving control is executed, and (ii) the set vehicle moving speed V_SET is equal to or smaller than the predetermined vehicle moving speed V_TH (i.e., the constant speed acceleration determination change condition is satisfied), the vehicle driving assist apparatus 10 controls the driving force applied to the own vehicle 100 for accelerating the own vehicle 100 to a value which is smaller than the driving force realized while (i) the enlarged constant speed moving control is executed, and (ii) the set vehicle moving speed V_SET is greater than the predetermined vehicle moving speed V_TH.

In particular, when the own vehicle 100 is required to be accelerated while the set vehicle moving speed V_SET is greater than the predetermined vehicle moving speed V_TH, the vehicle driving assist apparatus 10 executes the optimum acceleration control. On the other hand, when the own vehicle 100 is required to be accelerated, and the set vehicle moving speed V_SET is equal to or smaller than the predetermined vehicle moving speed V_TH, the vehicle driving assist apparatus 10 executes a limited acceleration control. The limited acceleration control is a control to (i) calculate the required driving force PD_REQ which corresponds to the driving force which is smaller than the driving force realized by the optimum acceleration control by a predetermined value PD_L (i.e., the driving force which is smaller than the driving force output from the driving apparatus 21 operating with the optimum energy efficient), and (ii) accelerate the own vehicle 100 by controlling the operations of the driving apparatus 21 so as to output the driving force corresponding to the calculated required driving force PD_REQ.

Thereby, when the own vehicle 100 starts to be accelerated when the own vehicle moving speed VO is small since the set vehicle moving speed V_SET is set to a small vehicle moving speed while the enlarged constant speed moving control is executed, the driving force applied to the own vehicle 100 is controlled to the small driving force. Thereby, the driver D can be prevented from having the excessive acceleration discomfort.

It should be noted that the own vehicle 100 can be sufficiently accelerated even by the small driving force when the road on which the own vehicle 100 moves is an even road or a downward slope. Also, when the road on which the own vehicle 100 moves is an upward slope, but the gradient of the upward slope is small, the own vehicle 100 can be sufficiently accelerated even by the small driving force. On the other hand, when the road on which the own vehicle 100 moves is the upward slope, and the gradient of the upward slope is great, the own vehicle 100 may not be sufficiently accelerated by the small driving force.

Accordingly, the constant speed acceleration determination change condition may include a condition that the gradient RA of the road on which the own vehicle 100 moves is equal to or smaller than a predetermined upward slope gradient RA_TH in addition to the condition that the set vehicle moving speed V_SET is equal to or smaller than the predetermined vehicle moving speed V_TH. In other words, the constant speed acceleration determination change condition may include a condition that the gradient RA of the road on which the own vehicle 100 moves represents the upward slope, and an absolute value of the gradient RA is equal to or smaller than the predetermined upward slope gradient RA_TH in addition to the condition that the set vehicle moving speed V_SET is equal to or smaller than the predetermined vehicle moving speed V_TH.

Further, in this case, the vehicle driving assist apparatus 10 may be configured to acquire the driving force for accelerating the own vehicle 100 by applying the own vehicle moving speed VO and the gradient RA of the road to a map or the like when the constant speed acceleration determination change condition becomes satisfied, and the vehicle driving assist apparatus 10 starts to execute the limited acceleration control. In this case, the vehicle driving assist apparatus 10 decreases the driving force applied to the own vehicle 100 as the own vehicle moving speed VO decreases. In addition, the vehicle driving assist apparatus 10 decreases the driving force applied to the own vehicle 100 as the gradient RA of the road decreases.

As described above, the driving force for accelerating the own vehicle 100 is set, depending on the gradient RA of the road on which the own vehicle 100 moves. Thereby, it can be ensured that the own vehicle 100 is sufficiently accelerated while the enlarged constant speed moving control is executed.

<Enlarged Following Moving Control, Etc.>

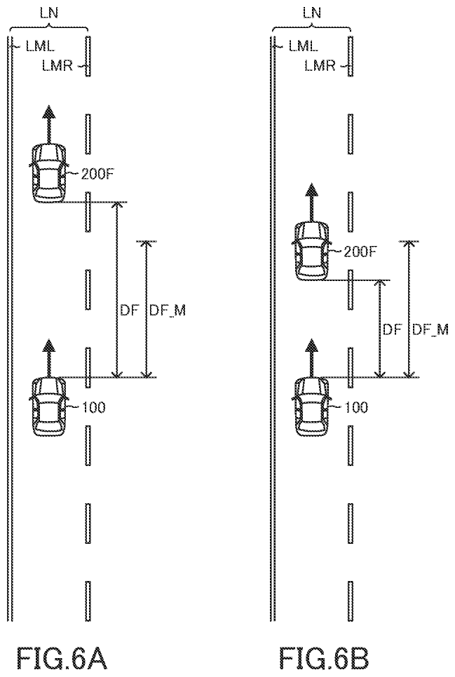

As shown in FIG. 6, when there is a preceding vehicle 200F, but there is no following vehicle 200R while the enlarged moving assist control is executed, the vehicle driving assist apparatus 10 determines whether the own vehicle 100 moves with a distance between the own vehicle 100 and the preceding vehicle 200F which is equal to or greater than a middle distance. In other words, the vehicle driving assist apparatus 10 determines whether a preceding vehicle separation degree (i.e., a degree that the own vehicle 100 separates from the preceding vehicle 200F) is greater than a predetermined preceding vehicle separation degree.

In this embodiment, the vehicle driving assist apparatus 10 determines whether the preceding vehicle separation degree is greater than the predetermined preceding vehicle separation degree by determining whether a forward middle distance condition is satisfied. The forward middle distance condition is a condition that the forward inter-vehicle distance DF is greater than a predetermined distance or a forward middle distance determination value DF_M.

In this embodiment, the forward middle distance determination value DF_M is one of acceleration start determination parameters. Accordingly, when a following acceleration determination change condition is satisfied, the vehicle driving assist apparatus 10 sets the forward middle distance determination value DF M to a value which is smaller than the forward middle distance determination value DF_M set when the preceding vehicle moving speed VF is greater than the predetermined vehicle moving speed V_TH. The following acceleration determination change condition is a condition that the preceding vehicle moving speed VF is equal to or smaller than the predetermined vehicle moving speed V_TH. In other words, when the following acceleration determination change condition is satisfied, the vehicle driving assist apparatus 10 sets the predetermined preceding vehicle separation degree to a degree which is smaller than the predetermined preceding vehicle separation degree set when the preceding vehicle moving speed VF is greater than the predetermined vehicle moving speed V_TH.

In particular, when the preceding vehicle moving speed VF is greater than the predetermined vehicle moving speed V_TH, the vehicle driving assist apparatus 10 sets the forward middle distance determination value DF_M to a standard forward middle distance determination value DF_M_S (i.e., a standard value of the forward middle distance determination value DF_M). On the other hand, when the preceding vehicle moving speed VF is equal to or smaller than the predetermined vehicle moving speed V_TH, the vehicle driving assist apparatus 10 sets the forward middle distance determination value DF_M to a decreased forward middle distance determination value DF_M_L (i.e., a value which is smaller than the standard forward middle distance determination value DF_M_S by a predetermined value DF_M_P). It should be noted that the forward middle distance determination value DF_M is set to a distance which is smaller than the preceding vehicle determination distance DF_TH.

It should be noted that the vehicle driving assist apparatus 10 may be configured to set the forward middle distance determination value DF_M, depending on the preceding vehicle moving speed VF similar to when the constant speed acceleration determination change condition is satisfied. In this case, when the preceding vehicle moving speed VF is between the predetermined vehicle moving speed V_TH and a certain vehicle moving speed V_P, the vehicle driving assist apparatus 10 may be configured to set the forward middle distance determination value DF_M to a value which decreases as the preceding vehicle moving speed VF decreases. On the other hand, when the preceding vehicle moving speed VF is smaller than the certain vehicle moving speed V_P, the vehicle driving assist apparatus 10 may be configured to set the forward middle distance determination value DF_M to the same value as the forward middle distance determination value DF_M which is set when the preceding vehicle moving speed VF is equal to the certain vehicle moving speed V_P.

<First Enlarged Following Moving Control>

As shown in FIG. 6A, when the forward inter-vehicle distance DF is greater than the forward middle distance determination value DF_M, the vehicle driving assist apparatus 10 determines that the forward middle distance condition is satisfied and executes a first enlarged following moving control as the enlarged following moving control.

While the first enlarged following moving control is executed, the vehicle driving assist apparatus 10 determines whether the own vehicle 100 is approaching the preceding vehicle 200F with a relatively great speed. In other words, the vehicle driving assist apparatus 10 determines whether a preceding vehicle approaching degree is greater than a predetermined degree or a predetermined preceding vehicle approaching degree. The preceding vehicle approaching degree is a degree that the own vehicle 100 is approaching the preceding vehicle 200F.

In this embodiment, the vehicle driving assist apparatus 10 determines whether the preceding vehicle approaching degree is greater than the predetermined preceding vehicle approaching degree by determining whether a forward approaching condition is satisfied. The forward approaching condition is a condition that the own vehicle moving speed VO is greater than the preceding vehicle moving speed VF, and a preceding vehicle moving speed difference ΔVF is greater than a predetermined value or a forward approaching vehicle moving speed difference ΔVF_A. The preceding vehicle moving speed difference ΔVF is a difference between the own vehicle moving speed VO and the preceding vehicle moving speed VF.

When the vehicle driving assist apparatus 10 determines that the forward approaching condition is satisfied, the vehicle driving assist apparatus 10 starts to execute the coasting deceleration control.

On the other hand, when the vehicle driving assist apparatus 10 determines that the forward approaching condition is not satisfied, the vehicle driving assist apparatus 10 determines whether (i) the own vehicle moving speed VO is considerably small, and (ii) the own vehicle 100 is separating from the preceding vehicle 200F with a relatively great speed. In other words, the vehicle driving assist apparatus 10 determines whether the preceding vehicle separation degree is greater than a predetermined degree or the predetermined preceding vehicle separation degree. The preceding vehicle separation degree is a degree that the own vehicle 100 is separating from the preceding vehicle 200F.

In this embodiment, the vehicle driving assist apparatus 10 determines whether the preceding vehicle separation degree is greater than the predetermined preceding vehicle separation degree by determining whether a forward separation condition is satisfied. The forward separation condition is a condition that (i) the own vehicle moving speed VO is smaller than the enlarged vehicle moving speed lower limit VL_E, (ii) the own vehicle moving speed VO is smaller than the preceding vehicle moving speed VF, and (iii) the preceding vehicle moving speed difference ΔVF (i.e., the difference between the own vehicle moving speed VO and the preceding vehicle moving speed VF) is greater than a predetermined value or a forward separating vehicle moving speed difference ΔVF_B. It should be noted that the forward separating vehicle moving speed difference ΔVF_B may be equal to or different from the forward approaching vehicle moving speed difference ΔVF_A.

In this embodiment, the enlarged vehicle moving speed lower limit VL_E and the ΔVF_B are the acceleration start determination parameters. Accordingly, when the following acceleration determination change condition (i.e., a condition that the preceding vehicle moving speed VF is equal to or smaller than the predetermined vehicle moving speed V_TH) is satisfied, the vehicle driving assist apparatus 10 (i) sets the enlarged vehicle moving speed lower limit VL_E to a value which realizes a smaller difference between the enlarged vehicle moving speed lower limit VL_E and the set vehicle moving speed V_SET than the difference between the enlarged vehicle moving speed lower limit VL_E and the set vehicle moving speed V_SET realized when the preceding vehicle moving speed VF is greater than the predetermined vehicle moving speed V_TH and (ii) sets the ΔVF_B to a small value. In other words, when the following acceleration determination change condition (i.e., the condition that the preceding vehicle moving speed VF is equal to or smaller than the predetermined vehicle moving speed V_TH) is satisfied, the vehicle driving assist apparatus 10 sets the predetermined preceding vehicle separation degree to a degree which is smaller than the predetermined preceding vehicle separation degree set when the preceding vehicle moving speed VF is greater than the predetermined vehicle moving speed V_TH.

In particular, when the preceding vehicle moving speed VF is greater than the predetermined vehicle moving speed V_TH, the vehicle driving assist apparatus 10 (i) sets the enlarged vehicle moving speed lower limit VL_E to the standard lower limit VL_E_S and (ii) sets the forward separation vehicle moving speed difference ΔVF_B to a standard forward separation vehicle moving speed difference ΔVF_B_S (i.e., a standard value of the forward separation vehicle moving speed difference ΔVF_B). On the other hand, when the preceding vehicle moving speed VF is equal to or smaller than the predetermined vehicle moving speed V_TH, the vehicle driving assist apparatus 10 (i) sets the enlarged vehicle moving speed lower limit VL_E to an increased lower limit VL_E_H (i.e., a value which is greater than the standard lower limit VL_E_S by a predetermined value VL_P) and (ii) sets forward separation vehicle moving speed difference ΔVF_B to a decreased forward separation vehicle moving speed difference ΔVF_B_L (i.e. a value which is smaller than the standard forward separation vehicle moving speed difference ΔVF_B_S by a predetermined value VF_B) It should be noted that the increased lower limit VL_E_H is set to a value which is smaller than the set vehicle moving speed V_SET.

It should be noted that the vehicle driving assist apparatus 10 may be configured to set the enlarged vehicle moving speed lower limit VL_E and the forward separating vehicle moving speed difference ΔVF_B, depending on the preceding vehicle moving speed VF similar to when the constant speed acceleration determination change condition is satisfied. In this case, when the preceding vehicle moving speed VF is between the predetermined vehicle moving speed V_TH and the certain vehicle moving speed V_P, the vehicle driving assist apparatus 10 may be configured to set the enlarged vehicle moving speed lower limit VL_E to a value which increases as the preceding vehicle moving speed VF decreases. On the other hand, when the preceding vehicle moving speed VF is smaller than the certain vehicle moving speed V_P, the vehicle driving assist apparatus 10 may be configured to set the enlarged vehicle moving speed lower limit VL_E to the same value as the enlarged vehicle moving speed lower limit VL_E which is set when the preceding vehicle moving speed VF is equal to the certain vehicle moving speed V_P. Further, when the preceding vehicle moving speed VF is between the predetermined vehicle moving speed V_TH and the certain vehicle moving speed V_P, the vehicle driving assist apparatus 10 may be configured to set the ΔVF_B to a value which decreases as the preceding vehicle moving speed VF decreases. On the other hand, when the preceding vehicle moving speed VF is smaller than the certain vehicle moving speed V_P, the vehicle driving assist apparatus 10 may be configured to set the ΔVF_B to the same value as the ΔVF_B as the value as the AVF_B which is set when the preceding vehicle moving speed VF is equal to the certain vehicle moving speed V_P.

When the vehicle driving assist apparatus 10 determines that the forward separation condition is satisfied, the vehicle driving assist apparatus 10 starts to execute an acceleration control. In this case, when the following acceleration determination change condition (i.e., the condition that the preceding vehicle moving speed VF is equal to or smaller than the predetermined vehicle moving speed V_TH) is satisfied, the vehicle driving assist apparatus 10 controls the driving force applied to the own vehicle 100 for accelerating the own vehicle 100 to the driving force which is smaller than the driving force controlled when the preceding vehicle moving speed VF is greater than the predetermined vehicle moving speed V_TH. In particular, when the preceding vehicle moving speed VF is greater than the predetermined vehicle moving speed V_TH, the vehicle driving assist apparatus 10 executes the optimum acceleration control as the acceleration control. On the other hand, when the preceding vehicle moving speed VF is equal to or smaller than the predetermined vehicle moving speed V_TH, the vehicle driving assist apparatus 10 executes the limited acceleration control as the acceleration control.

On the other hand, when the vehicle driving assist apparatus 10 determines that the forward separation condition is not satisfied, the vehicle driving assist apparatus 10 starts to execute a steady moving control. In this embodiment, the steady control is a control to (i) calculate the required driving force PD_REQ or the required braking force PB_REQ for maintaining the current own vehicle moving speed VO and (ii) control the operations of the driving apparatus 21 and/or the braking apparatus 22 to output the driving force corresponding to the required driving force PD_REQ or the braking force corresponding to the required braking force PB_REQ.

It should be noted that similar to the constant speed acceleration determination change condition, the following acceleration determination change condition may include a condition that the gradient RA of the road on which the own vehicle 100 moves is equal to or smaller than the predetermined upward slope gradient RA_TH in addition to the condition that the set vehicle moving speed V_SET is equal to or smaller than the predetermined vehicle moving speed V_TH. In other words, the following acceleration determination change condition may include a condition that (i) the gradient RA of the road on which the own vehicle 100 moves represents the upward slope, and (ii) an absolute value of the gradient RA is equal to or smaller than the predetermined upward slope gradient RA_TH in addition to the condition that the set vehicle moving speed V_SET is equal to or smaller than the predetermined vehicle moving speed V_TH.

Further, in this case, the vehicle driving assist apparatus 10 may be configured to acquire the driving force for accelerating the own vehicle 100 by applying the own vehicle moving speed VO and the gradient RA of the road to a map or the like when the following acceleration determination change condition becomes satisfied, and the vehicle driving assist apparatus 10 starts to execute the limited acceleration control. In this case, the vehicle driving assist apparatus 10 may decrease the driving force applied to the own vehicle 100 as the own vehicle moving speed VO decreases. In addition, the vehicle driving assist apparatus 10 may decrease the driving force applied to the own vehicle 100 as the gradient RA of the road decreases.

As described above, the driving force for accelerating the own vehicle 100 is set, depending on the gradient RA of the road on which the own vehicle 100 moves. Thereby, it can be ensured that the own vehicle 100 is sufficiently accelerated while the enlarged constant speed moving control is executed.

<Second Enlarged Following Moving Control>

On the other hand, as shown in FIG. 6B, when the forward inter-vehicle distance DF is equal to or smaller than the forward middle distance determination value DF_M, the vehicle driving assist apparatus 10 determines that the forward middle distance condition is not satisfied and starts to execute a second enlarged following moving control as the enlarged following moving control.

While the second enlarged following moving control is executed, the vehicle driving assist apparatus 10 determines whether the own vehicle 100 moves considerably near the preceding vehicle 200F. In this embodiment, the vehicle driving assist apparatus 10 determines whether the own vehicle 100 moves considerably near the preceding vehicle 200F by determining whether a forward short distance condition is satisfied. The forward short distance condition is a condition that the forward inter-vehicle distance DF is equal to or smaller than a predetermined distance or a forward short distance determination value DF_S. It should be noted that the forward short distance determination value DF_S is set to a value which is smaller than the forward middle distance determination value DF_M.

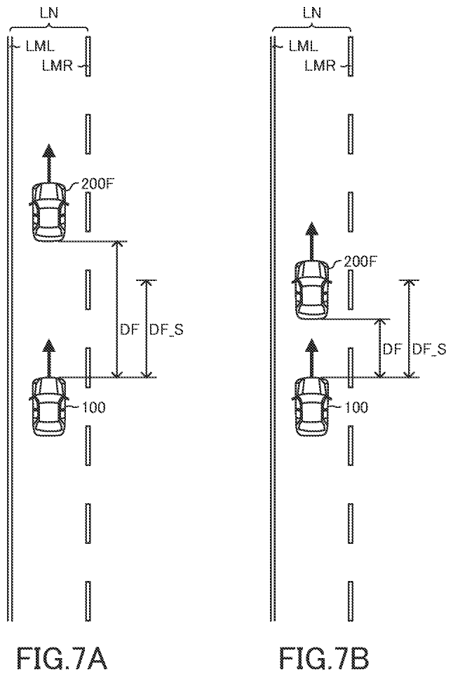

As shown in FIG. 7A, when the forward inter-vehicle distance DF is greater than the forward short distance determination value DF_S, the vehicle driving assist apparatus 10 determines that the forward short distance condition is not satisfied and executes the coasting deceleration control.

On the other hand, as shown in FIG. 7B, when the forward inter-vehicle distance DF is equal to or smaller than the forward short distance determination value DF_S, the vehicle driving assist apparatus 10 determines that the forward short distance condition is satisfied and executes the ordinary moving assist control. It should be noted that in this case, there is a preceding vehicle 200F and thus, the vehicle driving assist apparatus 10 executes the ordinary following moving control as the ordinary moving assist control.

<Case that there is only Following Vehicle>

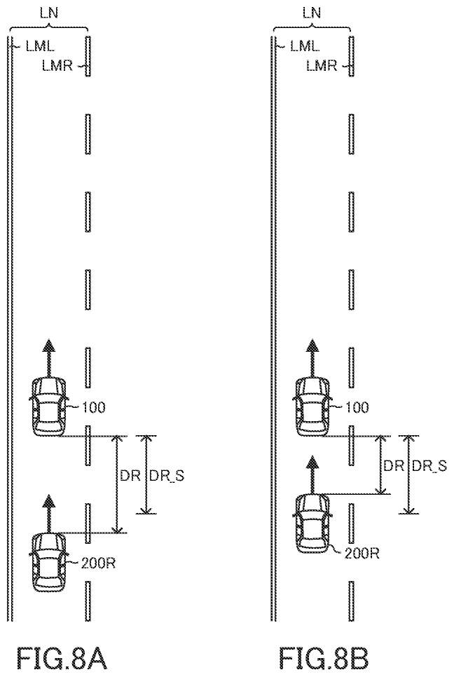

As shown in FIG. 8, when there is no preceding vehicle 200F, but there is a following vehicle 200R, the vehicle driving assist apparatus 10 determines whether the own vehicle 100 moves considerably near the following vehicle 200R. In other words, the vehicle driving assist apparatus 10 determines whether a following vehicle separation degree (i.e., a degree that the own vehicle 100 separates from the following vehicle 200R) is smaller than a predetermined degree or a predetermined following vehicle separation degree. In this embodiment, the vehicle driving assist apparatus 10 determines whether the following vehicle separation degree is smaller than the predetermined following vehicle separation degree by determining whether a rearward short distance condition is satisfied. The rearward short distance condition is a condition that the rearward inter-vehicle distance DR is equal to or smaller than a predetermined distance or a rearward short distance determination value DR_S.

In this embodiment, the rearward short distance determination value DR_S is one of the acceleration start determination parameters. Accordingly, when the constant speed acceleration determination change condition (i.e., the condition that the set vehicle moving speed V_SET is equal to or smaller than the predetermined vehicle moving speed V_TH) is satisfied, the vehicle driving assist apparatus 10 sets the rearward short distance determination value DR_S to a value which is greater than the rearward short distance determination value DR_S which is set when the set vehicle moving speed V_SET is greater than the predetermined vehicle moving speed V_TH. In other words, when the constant speed acceleration determination change condition (i.e., the condition that the set vehicle moving speed V_SET is equal to or smaller than the predetermined vehicle moving speed V_TH) is satisfied, the vehicle driving assist apparatus 10 sets the predetermined following vehicle separation degree to a degree which is greater than the predetermined following vehicle separation degree which is set when the set vehicle moving speed V_SET is greater than the predetermined vehicle moving speed V_TH.

In particular, when the set vehicle moving speed V_SET is greater than the predetermined vehicle moving speed V_TH, the vehicle driving assist apparatus 10 sets the rearward short distance determination value DR_S to a standard rearward short distance determination value DR_S_S (i.e., a standard value of the rearward short distance determination value DR_S). On the other hand, when the set vehicle moving speed V_SET is equal to or smaller than the predetermined vehicle moving speed V_TH, the vehicle driving assist apparatus 10 sets the rearward short distance determination value DR_S to an increased rearward short distance determination value DR_S_H (i.e., a value which is greater than the standard rearward short distance determination value DR_S_S by a predetermined value DR_S_P). It should be noted that the rearward short distance determination value DR_S is set to a distance which is smaller than the following vehicle determination distance DR_TH.

<First Enlarged Constant Speed Moving Control>

As shown in FIG. 8A, when the rearward inter-vehicle distance DR is greater than the rearward short distance determination value DR_S, the vehicle driving assist apparatus 10 determines that the rearward short distance condition is not satisfied and executes a first enlarged constant speed moving control as the enlarged constant speed moving control.

While the first enlarged constant speed moving control is executed, the vehicle driving assist apparatus 10 determines whether (i) the following vehicle 200R is approaching the own vehicle 100 with a relatively great speed, and (ii) the own vehicle moving speed VO is tolerated to be increased. In other words, the vehicle driving assist apparatus 10 determines whether (i) a following vehicle approaching degree (i.e., a degree that the following vehicle 200R is approaching the own vehicle 100) is greater than a predetermined degree (i.e., a predetermined following vehicle approaching degree), and (ii) an acceleration tolerance degree (i.e., a degree that the own vehicle 100 is tolerated to be accelerated) is greater than a predetermined degree (i.e., a predetermined acceleration tolerance degree). In this embodiment, the vehicle driving assist apparatus 10 determines whether (i) the following vehicle approaching degree is greater than the predetermined following vehicle approaching degree, and (ii) the acceleration tolerance degree is greater than the predetermined acceleration tolerance degree by determining whether a rearward approaching condition is satisfied. The rearward approaching condition is a condition that (i) the own vehicle moving speed VO is smaller than the following vehicle moving speed VR (i.e., the vehicle moving speed of the following vehicle 200R), (ii) a following vehicle moving speed difference ΔVR (i.e., a difference between the own vehicle moving speed VO and the following vehicle moving speed VR) is greater than a predetermined value (i.e., a rearward approaching vehicle moving speed difference ΔVR_A), and (iii) the own vehicle moving speed VO is smaller than the enlarged vehicle moving speed upper limit VU_E.

In this embodiment, the enlarged vehicle moving speed upper limit VU_E and the ΔVR_A are the acceleration start determination parameters. Accordingly, when the constant speed acceleration determination change condition (i.e., the condition that the set vehicle moving speed V_SET is equal to or smaller than the predetermined vehicle moving speed V_TH) is satisfied, the vehicle driving assist apparatus 10 (i) sets the enlarged vehicle moving speed upper limit VU_E to a value which realizes a greater difference between the enlarged vehicle moving speed upper limit VU_E and the set vehicle moving speed V_SET than the difference between the enlarged vehicle moving speed upper limit VU_E and the set vehicle moving speed V_SET realized when the set vehicle moving speed V_SET is greater than the predetermined vehicle moving speed V_TH and (ii) sets the rearward approaching vehicle moving speed difference ΔVR_A to a small value. In other words, when the constant speed acceleration determination change condition (i.e., the condition that the set vehicle moving speed V_SET is equal to or smaller than the predetermined vehicle moving speed V_TH) is satisfied, the vehicle driving assist apparatus 10 (i) sets the predetermined following vehicle approaching degree to a degree which is smaller than the predetermined following vehicle approaching degree set when the set vehicle moving speed V_SET is greater than the predetermined vehicle moving speed V_TH and (ii) sets the predetermined acceleration tolerance degree to a small degree.

In particular, when the set vehicle moving speed V_SET is greater than the predetermined vehicle moving speed V_TH, the vehicle driving assist apparatus 10 (i) sets the enlarged vehicle moving speed upper limit VU_E to a standard upper limit VU_E_S (i.e., a standard value of the enlarged vehicle moving speed upper limit VU_E) and (ii) sets the rearward approaching vehicle moving speed difference ΔVR_A to a standard rearward approaching vehicle moving speed difference ΔVR_A_S (i.e., a standard value of the rearward approaching vehicle moving speed difference ΔVR_A). On the other hand, when the set vehicle moving speed V_SET is equal to or smaller than the predetermined vehicle moving speed V_TH, the vehicle driving assist apparatus 10 (i) sets the enlarged vehicle moving speed upper limit VU_E to an increased upper limit VU_E_H (i.e., a value which is greater than the standard upper limit VU_E_S by a predetermined value VU_E_P) and (ii) sets the rearward approaching vehicle moving speed difference ΔVR_A to a decreased rearward approaching vehicle moving speed difference ΔVR_A_L (i.e., a value which is smaller than the standard rearward approaching vehicle moving speed difference ΔVR_A_S by a predetermined value VR_A_P). It should be noted that the enlarged vehicle moving speed upper limit VU_E is set to a value which is smaller than a speed limit regulating the own vehicle 100.

When the vehicle driving assist apparatus 10 determines that the rearward approaching condition is satisfied, the vehicle driving assist apparatus 10 starts to execute the acceleration control. In this case, when the constant speed acceleration determination change condition (i.e., the condition that the set vehicle moving speed V_SET is equal to or smaller than the predetermined vehicle moving speed V_TH) is satisfied, the vehicle driving assist apparatus 10 controls the driving force applied to the own vehicle 100 for accelerating the own vehicle 100 to the driving force which is smaller than the driving force controlled when the set vehicle moving speed V_SET is greater than the predetermined vehicle moving speed V_TH. In particular, when the set vehicle moving speed V_SET is greater than the predetermined vehicle moving speed V_TH, the vehicle driving assist apparatus 10 executes the optimum acceleration control as the acceleration control. On the other hand, when the set vehicle moving speed V_SET is equal to or smaller than the predetermined vehicle moving speed V_TH, the vehicle driving assist apparatus 10 executes the limited acceleration control as the acceleration control.

On the other hand, when the vehicle driving assist apparatus 10 determines that the rearward approaching condition is not satisfied, the vehicle driving assist apparatus 10 starts to execute the steady moving control.

<Second Enlarged Constant Speed Moving Control>

On the other hand, as shown in FIG. 8B, when the rearward inter-vehicle distance DR is equal to or smaller than the rearward short distance determination value DR_S, the vehicle driving assist apparatus 10 determines that the rearward short distance condition is satisfied and starts to execute a second enlarged constant speed moving control.

While the second enlarged constant speed moving control is executed, the vehicle driving assist apparatus 10 determines whether the own vehicle moving speed VO is tolerated to be increased. In other words, the vehicle driving assist apparatus 10 determines whether the acceleration tolerance degree (i.e., the degree that the own vehicle 100 is tolerated to be accelerated) is greater than a predetermined degree (i.e., the predetermined acceleration tolerance degree). In this embodiment, the vehicle driving assist apparatus 10 determines whether the acceleration tolerance degree is greater than the predetermined acceleration tolerance degree by determining whether an acceleration tolerance condition is satisfied. The acceleration tolerance condition is a condition that the own vehicle moving speed VO is smaller than the enlarged vehicle moving speed upper limit VU_E.

In this embodiment, the enlarged vehicle moving speed upper limit VU_E is the acceleration start determination parameter. Accordingly, when the constant speed acceleration determination change condition (i.e., the condition that the set vehicle moving speed V_SET is equal to or smaller than the predetermined vehicle moving speed V_TH) is satisfied, the vehicle driving assist apparatus 10 sets the enlarged vehicle moving speed upper limit VU_E to a value which realizes a greater difference between the enlarged vehicle moving speed upper limit VU_E and the set vehicle moving speed V_SET than the difference between the enlarged vehicle moving speed upper limit VU_E and the set vehicle moving speed V_SET realized when the set vehicle moving speed V_SET is greater than the predetermined vehicle moving speed V_TH. In other words, when the constant speed acceleration determination change condition (i.e., the condition that the set vehicle moving speed V_SET is equal to or smaller than the predetermined vehicle moving speed V_TH) is satisfied, the vehicle driving assist apparatus 10 sets the predetermined acceleration tolerance degree to a degree which is smaller than the predetermined acceleration tolerance degree set when the preceding vehicle moving speed VF is greater than the predetermined vehicle moving speed V_TH. In particular, when the set vehicle moving speed V_SET is greater than the predetermined vehicle moving speed V_TH, the vehicle driving assist apparatus 10 sets the enlarged vehicle moving speed upper limit VU_E to the standard upper limit VU_E_S. On the other hand, when the set vehicle moving speed V_SET is equal to or smaller than the predetermined vehicle moving speed V_TH, the vehicle driving assist apparatus 10 sets the enlarged vehicle moving speed upper limit VU_E to the increased upper limit VU_E_H (i.e., the value which is greater than the standard upper limit VU_E_S by the predetermined value VU_E_P). It should be noted that the enlarged vehicle moving speed upper limit VU_E is set to a value which is smaller than the speed limit regulating the own vehicle 100.

When the vehicle driving assist apparatus 10 determines that the acceleration tolerance condition is satisfied, the vehicle driving assist apparatus 10 starts to execute the acceleration control. In this case, when the constant speed acceleration determination change condition (i.e., the condition that the set vehicle moving speed V_SET is equal to or smaller than the predetermined vehicle moving speed V_TH) is satisfied, the vehicle driving assist apparatus 10 controls the driving force applied to the own vehicle 100 for accelerating the own vehicle 100 to the driving force which is smaller than the driving force controlled when the set vehicle moving speed V_SET is greater than the predetermined vehicle moving speed V_TH. In particular, when the set vehicle moving speed V_SET is greater than the predetermined vehicle moving speed V_TH, the vehicle driving assist apparatus 10 executes the optimum acceleration control as the acceleration control. On the other hand, when the set vehicle moving speed V_SET is equal to or smaller than the predetermined vehicle moving speed V_TH, the vehicle driving assist apparatus 10 executes the limited acceleration control as the acceleration control.

On the other hand, when the vehicle driving assist apparatus 10 determines that the acceleration tolerance condition is not satisfied, the vehicle driving assist apparatus 10 starts to execute the ordinary moving assist control. It should be noted that in this case, there is no preceding vehicle 200F and thus, the vehicle driving assist apparatus 10 executes the ordinary constant speed moving control as the ordinary moving assist control.

<Case That There Are Preceding Vehicle and Following Vehicle>

When (i) the economy moving condition is satisfied, (ii) the moving assist execution condition becomes satisfied, and (iii) there are the preceding vehicle 200F and the following vehicle 200R, the vehicle driving assist apparatus 10 starts to execute the ordinary moving assist control. It should be noted that in this case, there is the preceding vehicle 200F and thus, the vehicle driving assist apparatus 10 executes the ordinary following moving control.

<Advantages>

With the vehicle driving assist apparatus 10, when the driver D has a high possibility of having the excessive deceleration discomfort or the excessive acceleration discomfort, the own vehicle 100 starts to be accelerated before the own vehicle moving speed VO excessively decreases, and the driving force for accelerating the own vehicle 100 is limited to a small value. Thereby, the driver D can be prevented from having the excessive deceleration discomfort or the excessive acceleration discomfort. In addition, when there is the following vehicle 200R, the own vehicle moving speed VO can be prevented from excessively decreasing. Thereby, the own vehicle 100 can be prevented from disturbing a traffic.

On the other hand, when the driver D has a low probability of having the excessive deceleration discomfort or the excessive acceleration discomfort, the coasting deceleration control is executed for a long time as possible for decelerating the own vehicle 100, and the optimum acceleration control is executed for accelerating the own vehicle 100. Thereby, the energy efficient E of the driving apparatus 21 can be improved. Thereby, with the vehicle driving assist apparatus 10, the driver D can be prevented from having the excessive deceleration discomfort and the excessive acceleration discomfort, and the energy efficient E of the driving apparatus 21 can be improved.

<Specific Operations of Vehicle Driving Assist Apparatus>

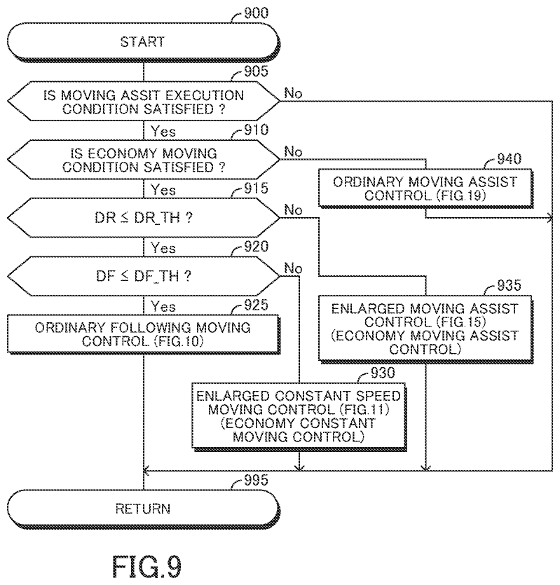

Next, specific operations of the vehicle driving assist apparatus 10 will be described. The CPU of the ECU 90 of the vehicle driving assist apparatus 10 is configured or programmed to execute a routine shown in FIG. 9 with a predetermined calculation cycle. Thus, at a predetermined time, the CPU starts to execute a process from a step 900 of the routine shown in FIG. 9 and proceeds with the process to a step 905 to determine whether the moving assist execution condition is satisfied.

When the CPU determines “Yes” at the step 905, the CPU proceeds with the process to a step 910 to determine whether the economy moving condition is satisfied.

When the CPU determines “Yes” at the step 910, the CPU proceeds with the process to a step 915 to determine whether a following vehicle condition is satisfied. The following vehicle condition is a condition that there is a following vehicle 200R. In this embodiment, the CPU determines that the following vehicle condition is satisfied by determining whether the rearward inter-vehicle distance DR is equal to or smaller than the following vehicle determination distance DR_TH.

When the CPU determines “Yes” at the step 915, the CPU proceeds with the process to a step 920 to determine whether a preceding vehicle condition is satisfied. The preceding vehicle condition is a condition that there is a preceding vehicle 200F. In this embodiment, the CPU determines whether the preceding vehicle condition is satisfied by determining whether the forward inter-vehicle distance DF is equal to or smaller than the preceding vehicle determination distance DF_TH.

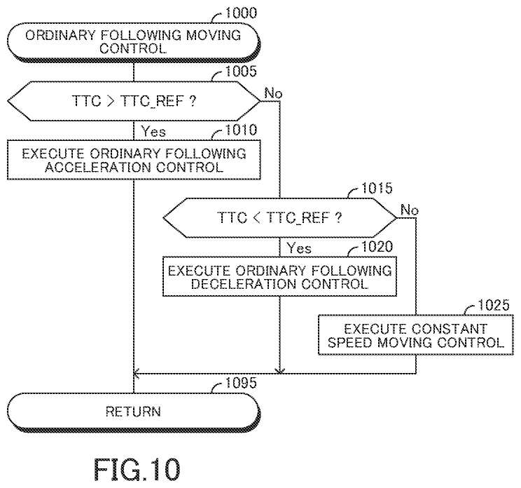

When the CPU determines “Yes” at the step 920, the CPU proceeds with the process to a step 925 to execute the ordinary following moving control by executing a routine shown in FIG. 10. Thus, when the CPU proceeds with the process to the step 925, the CPU starts to execute a process from a step 1000 of the routine shown in FIG. 10 and proceeds with the process to a step 1005 to determine whether an ordinary following acceleration condition is satisfied. In this embodiment, the CPU determines whether the ordinary following acceleration condition is satisfied by determining whether the predicted reaching time TTC is greater than the predetermined predicted reaching time TTC_REF.

When the CPU determines “Yes” at the step 1005, the CPU proceeds with the process to a step 1010 to execute the ordinary following acceleration control. Next, the CPU proceeds with the process to a step 995 of the routine shown in FIG. 9 via a step 1095 to terminate executing this routine once.

On the other hand, when the CPU determines “No” at the step 1005, the CPU proceeds with the process to a step 1015 to determine whether an ordinary following deceleration condition is satisfied. In this embodiment, the CPU determines whether the ordinary following deceleration condition is satisfied by determining whether the predicted reaching time TTC is smaller than the predetermined predicted reaching time TTC_REF.

When the CPU determines “Yes” at the step 1015, the CPU proceeds with the process to a step 1020 to execute the ordinary following deceleration control. Next, the CPU proceeds with the process to the step 995 of the routine shown in FIG. 9 via the step 1095 to terminate executing this routine once.

On the other hand, when the CPU determines “No” at the step 1015, the CPU proceeds with the process to a step 1025 to execute the steady moving control. Next, the CPU proceeds with the process to the step 995 of the routine shown in FIG. 9 via the step 1095 to terminate executing this routine once.

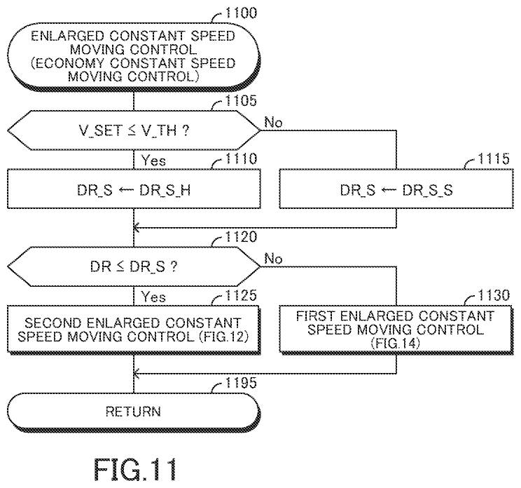

On the other hand, when the CPU determines “No” at the step 920, the CPU proceeds with the process to a step 930 to execute the enlarged constant speed moving control or the economy constant speed moving control by executing a routine shown in FIG. 11. Thus, when the CPU proceeds with the process to the step 930, the CPU starts to execute a process from a step 1100 of the routine shown in FIG. 11 and proceeds with the process to a step 1105 to determine whether the constant speed acceleration determination change condition is satisfied. In this embodiment, the CPU determines whether the constant speed acceleration determination change condition is satisfied by determining whether the set vehicle moving speed V_SET is equal to or smaller than the predetermined vehicle moving speed V_TH.

When the CPU determines “Yes” at the step 1105, the CPU proceeds with the process to a step 1110 to set the rearward short distance determination value DR_S to the increased rearward short distance determination value DR_S_H. Next, the CPU proceeds with the process to a step 1120.

On the other hand, when the CPU determines “No” at the step 1105, the CPU proceeds with the process to a step 1115 to set the rearward short distance determination value DR_S to the standard rearward short distance determination value DR S S. Next, the CPU proceeds with the process to the step 1120.

When the CPU proceeds with the process to the step 1120, the CPU determines whether the rearward short distance condition is satisfied. In this embodiment, the CPU determines whether the rearward short distance condition is satisfied by determining whether the rearward inter-vehicle distance DR is equal to or smaller than the rearward short distance determination value DR_S.

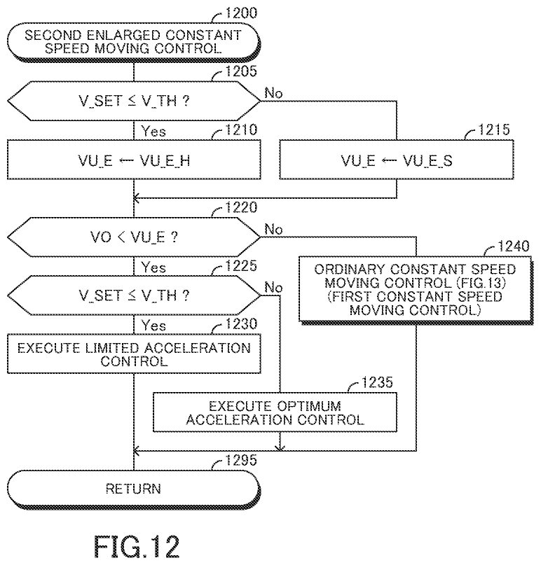

When the CPU determines “Yes” at the step 1120, the CPU proceeds with the process to a step 1125 to execute the second enlarged constant speed moving control by executing a routine shown in FIG. 12. Thus, when the CPU proceeds with the process to the step 1125, the CPU starts to execute a process from a step 1200 of the routine shown in FIG. 12 and proceeds with the process to a step 1205 to determine whether the constant speed acceleration determination change condition is satisfied. In this embodiment, the CPU determines whether the constant speed acceleration determination change condition is satisfied by determining whether the set vehicle moving speed V_SET is equal to or smaller than the predetermined vehicle moving speed V_TH.

When the CPU determines “Yes” at the step 1205, the CPU proceeds with the process to a step 1210 to set the enlarged vehicle moving speed upper limit VU_E to the increased upper limit VU_E_H. Next, the CPU proceeds with the process to a step 1220.

On the other hand, when the CPU determines “No” at the step 1205, the CPU proceeds with the process to a step 1215 to set the enlarged vehicle moving speed upper limit VU_E to the standard upper limit VU_E_S. Next, the CPU proceeds with the process to the step 1220.

When the CPU proceeds with the process to the step 1220, the CPU determines whether the acceleration tolerance condition is satisfied. In this embodiment, the CPU determines whether the acceleration tolerance condition is satisfied by determining whether the own vehicle moving speed VO is smaller than the enlarged vehicle moving speed upper limit VU_E.

When the CPU determines “Yes” at the step 1220, the CPU proceeds with the process to a step 1225 to determine whether the constant speed acceleration determination change condition is satisfied. In this embodiment, the CPU determines whether the constant speed acceleration determination change condition is satisfied by determining whether the set vehicle moving speed V_SET is equal to or smaller than the predetermined vehicle moving speed V_TH.

When the CPU determines “Yes” at the step 1225, the CPU proceeds with the process to a step 1230 to execute the limited acceleration control. Next, the CPU proceeds with the process to the step 995 via a step 1295 and a step 1195 of the routine shown in FIG. 11 to terminate executing this routine once.

On the other hand, when the CPU determines “No” at the step 1225, the CPU proceeds with the process to a step 1235 to execute the optimum acceleration control. Next, the CPU proceeds with the process to the step 995 via the step 1295 and the step 1195 of the routine shown in FIG. 11 to terminate executing this routine once.

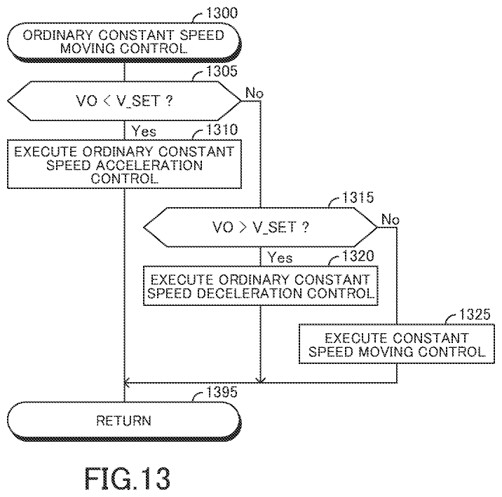

Further, when the CPU determines “No” at the step 1220, the CPU proceeds with the process to a step 1240 to execute the ordinary constant speed moving control by executing a routine shown in FIG. 13. Thus, when the CPU proceeds with the process to the step 1240, the CPU starts to execute a process from a step 1300 of the routine shown in FIG. 13 and proceeds with the process to a step 1305 to determine whether an ordinary constant speed acceleration condition is satisfied. In this embodiment, the CPU determines whether the ordinary constant speed acceleration condition is satisfied by determining whether the own vehicle moving speed VO is smaller than the set vehicle moving speed V_SET.

When the CPU determines “Yes” at the step 1305, the CPU proceeds with the process to a step 1310 to execute the ordinary constant speed acceleration control. Next, the CPU proceeds with the process to the step 995 of the routine shown in FIG. 9 via a step 1395, the step 1295 of the routine shown in FIG. 12, and the step 1195 of the routine shown in FIG. 11 to terminate executing this routine once.

On the other hand, when the CPU determine “No” at the step 1305, the CPU proceeds with the process to a step 1315 to determine whether an ordinary constant speed deceleration condition is satisfied. In this embodiment, the CPU determines whether the ordinary constant speed deceleration condition is satisfied by determining whether the own vehicle moving speed VO is greater than the set vehicle moving speed V_SET.

When the CPU determines “Yes” at the step 1315, the CPU proceeds with the process to a step 1320 to execute the ordinary constant speed deceleration control. Next, the CPU proceeds with the process to the step 995 of the routine shown in FIG. 9 via the step 1395, the step 1295 of the routine shown in FIG. 12, and the step 1195 of the routine shown in FIG. 11 to terminate executing this routine once.

On the other hand, when the CPU determines “No” at the step 1315, the CPU proceeds with the process to a step 1325 to execute the steady moving control. Next, the CPU proceeds with the process to the step 995 of the routine shown in FIG. 9 via the step 1395, the step 1295 of the routine shown in FIG. 12, and the step 1195 of the routine shown in FIG. 11 to terminate executing this routine once.

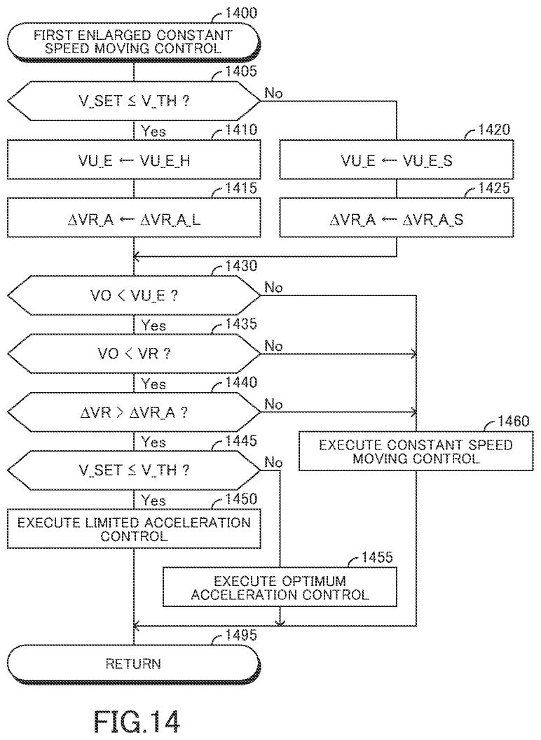

On the other hand, when the CPU determines “No” at the step 1120 of the routine shown in FIG. 11, the CPU proceeds with the process to a step 1130 to execute the first enlarged constant speed moving control by executing a routine shown in FIG. 14. Thus, when the CPU proceeds with the process to the step 1130, the CPU starts to execute a process from a step 1400 of the routine shown in FIG. 14 and proceeds with the process to a step 1405 to determine whether the constant speed acceleration determination change condition is satisfied. In this embodiment, the CPU determines whether the constant speed acceleration determination change condition is satisfied by determining whether the set vehicle moving speed V_SET is equal to or smaller than the predetermined vehicle moving speed V_TH.

When the CPU determines “Yes” at the step 1405, the CPU proceeds with the process to a step 1410 to set the enlarged vehicle moving speed upper limit VU_E to the increased upper limit VU_E_H. Next, the CPU proceeds with the process to a step 1415 to set the rearward approaching vehicle moving speed difference ΔVR_A to the decreased rearward approaching vehicle moving speed difference ΔVR_A_L. Next, the CPU proceeds with the process to a step 1430.

On the other hand, when the CPU determines “No” at the step 1405, the CPU proceeds with the process to a step 1420 to set the enlarged vehicle moving speed upper limit VU_E to the standard upper limit VU_E_S. Next, the CPU proceeds with the process to a step 1425 to set the rearward approaching vehicle moving speed difference ΔVR_A to the standard rearward approaching vehicle moving speed difference ΔVR_A_S. Next, the CPU proceeds with the process to the step 1430.

When the CPU proceeds with the process to the step 1430, the CPU determines whether one of satisfaction conditions for satisfying the rearward approaching condition is satisfied. In this embodiment, the CPU determines whether one of the satisfaction conditions for satisfying the rearward approaching condition is satisfied by determining whether the own vehicle moving speed VO is smaller than the enlarged vehicle moving speed upper limit VU_E.

When the CPU determines “Yes” at the step 1430, the CPU proceeds with the process to a step 1435 to determine whether one of the satisfaction conditions for satisfying the rearward approaching condition is satisfied. In this embodiment, the CPU determines whether one of the satisfaction conditions for satisfying the rearward approaching condition is satisfied by determining whether the own vehicle moving speed VO is smaller than the following vehicle moving speed VR.

When the CPU determines “Yes” at the step 1435, the CPU proceeds with the process to a step 1440 to determine whether one of the satisfaction conditions for satisfying the rearward approaching condition is satisfied. In this embodiment, the CPU determines whether one of the satisfaction conditions for satisfying the rearward approaching condition is satisfied by determining whether the following vehicle moving speed difference ΔVR (i.e., the difference between the own vehicle moving speed VO and the following vehicle moving speed VR) is greater than the rearward approaching vehicle moving speed difference ΔVR_A.

When the CPU determines “Yes” at the step 1440, the CPU proceeds with the process to a step 1445 to determine whether the constant speed acceleration determination change condition is satisfied. In this embodiment, the CPU determines whether the constant speed acceleration determination change condition is satisfied by determining whether the set vehicle moving speed V_SET is equal to or smaller than the predetermined vehicle moving speed V_TH.

When the CPU determines “Yes” at the step 1445, the CPU proceeds with the process to a step 1450 to execute the limited acceleration control. Next, the CPU proceeds with the process to the step 995 of the routine shown in FIG. 9 via a step 1495 and the step 1195 of the routine shown in FIG. 11 to terminate executing this routine once.

On the other hand, when the CPU determines “No” at the step 1445, the CPU proceeds with the process to a step 1455 to execute the optimum acceleration control. Next, the CPU proceeds with the process to the step 995 of the routine shown in FIG. 9 via the step 1495 and the step 1195 of the routine shown in FIG. 11 to terminate executing this routine once.

Further, when the CPU determines “No” at the step 1430, the step 1435, or the step 1440, the CPU proceeds with the process to a step 1460 to execute the steady moving control. Next, the CPU proceeds with the process to the step 995 of the routine shown in FIG. 9 via the step 1495 and the step 1195 of the routine shown in FIG. 11 to terminate executing this routine once.

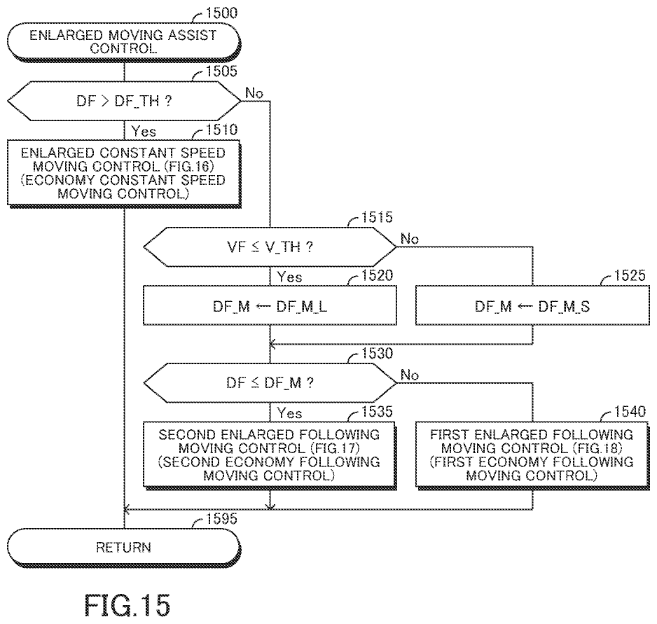

Further, when the CPU determines “No” at the step 915 of the routine shown in FIG. 9, the CPU proceeds with the process to a step 935 to execute the enlarged moving assist control by executing a routine shown in FIG. 15. Thus, when the CPU proceeds with the process to the step 935, the CPU starts to execute a process from a step 1500 of the routine shown in FIG. 15 and proceeds with the process to a step 1505 to determine whether there is no preceding vehicle 200F. In this embodiment, the CPU determines whether there is no preceding vehicle 200F by determining whether the forward inter-vehicle distance DF is greater than the preceding vehicle determination distance DF_TH.

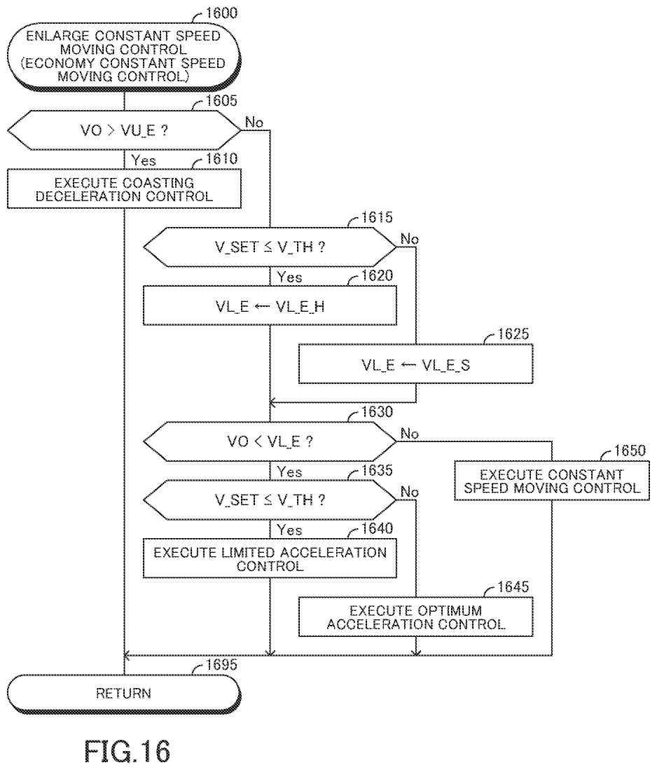

When the CPU determines “Yes” at the step 1505, the CPU proceeds with the process to a step 1510 to execute the enlarged constant speed moving control or the economy constant speed moving control by executing a routine shown in FIG. 16. Thus, when the CPU proceeds with the process to the step 1510, the CPU starts to execute a process from a step 1600 of the routine shown in FIG. 16 and proceeds with the process to a step 1605 to determine whether an enlarged constant speed deceleration condition is satisfied. In this embodiment, the CPU determines whether the enlarged constant speed deceleration condition is satisfied by determining whether the own vehicle moving speed VO is greater than the enlarged vehicle moving speed upper limit VU_E.

When the CPU determines “Yes” at the step 1605, the CPU proceeds with the process to a step 1610 to execute the coasting deceleration control. Next, the CPU proceeds with the process to the step 995 of the routine shown in FIG. 9 via a step 1695 and a step 1595 of the routine shown in FIG. 15 to terminate executing this routine once.

On the other hand, when the CPU determines “No” at the step 1605, the CPU proceeds with the process to a step 1615 to determine whether the constant speed acceleration determination change condition is satisfied. In this embodiment, the CPU determines whether the constant speed acceleration determination change condition is satisfied by determining whether the set vehicle moving speed V_SET is equal to or smaller than the predetermined vehicle moving speed V_TH.

When the CPU determines “Yes” at the step 1615, the CPU proceeds with the process to a step 1620 to set the enlarged vehicle moving speed lower limit VL_E to the increased lower limit VL_E_H. Next, the CPU proceeds with the process to a step 1630.

On the other hand, when the CPU determines “No” at the step 1615, the CPU proceeds with the process to a step 1625 to set the enlarged vehicle moving speed lower limit VL_E to the standard lower limit VL_E_S. Next, the CPU proceeds with the process to the step 1630.

When the CPU proceeds with the process to the step 1630, the CPU determines whether an enlarged constant speed acceleration condition is satisfied. In this embodiment, the CPU determines whether the enlarged constant speed acceleration condition is satisfied by determining whether the own vehicle moving speed VO is smaller than the enlarged vehicle moving speed lower limit VL_E.

When the CPU determines “Yes” at the step 1630, the CPU proceeds with the process to a step 1635 to determine whether the constant speed acceleration determination change condition is satisfied. In this embodiment, the CPU determines whether the constant speed acceleration determination change condition is satisfied by determining whether the set vehicle moving speed V_SET is equal to or smaller than the predetermined vehicle moving speed V_TH.

When the CPU determines “Yes” at the step 1635, the CPU proceeds with the process to a step 1640 to execute the limited acceleration control. Next, the CPU proceeds with the process to the step 995 of the routine shown in FIG. 9 via the step 1695 and the step 1595 of the routine shown in FIG. 15 to terminate executing this routine once.

On the other hand, when the CPU determines “No” at the step 1635, the CPU proceeds with the process to a step 1645 to execute the optimum acceleration control. Next, the CPU proceeds with the process to the step 995 of the routine shown in FIG. 9 via the step 1695 and the step 1595 of the routine shown in FIG. 15 to terminate executing this routine once.

Further, when the CPU determines “No” at the step 1630, the CPU proceeds with the process to a step 1650 to execute the steady moving control. Next, the CPU proceeds with the process to the step 995 of the routine shown in FIG. 9 via the step 1695 and the step 1595 of the routine shown in FIG. 15 to terminate executing this routine once.

Further, when the CPU determines “No” at the step 1505 of the routine shown in FIG. 15, the CPU proceeds with the process to a step 1515 to determine whether the following acceleration determination change condition is satisfied. In this embodiment, the CPU determines whether the following acceleration determination change condition is satisfied by determining whether the preceding vehicle moving speed VF is equal to or smaller than the predetermined vehicle moving speed V_TH.

When the CPU determines “Yes” at the step 1515, the CPU proceeds with the process to a step 1520 to set the forward middle distance determination value DF_M to the decreased forward middle distance determination value DF_M_L. Next, the CPU proceeds with the process to a step 1530.

On the other hand, when the CPU determines “No” at the step 1515, the CPU proceeds with the process to a step 1525 to set the forward middle distance determination value DF_M to the standard forward middle distance determination value DF_M_S. Next, the CPU proceeds with the process to the step 1530.

When the CPU proceeds with the process to the step 1530, the CPU determines whether the forward middle distance condition is satisfied. In this embodiment, the CPU determines whether the forward middle distance condition is satisfied by determining whether the forward inter-vehicle distance DF is equal to or smaller than the forward middle distance determination value DF_M.

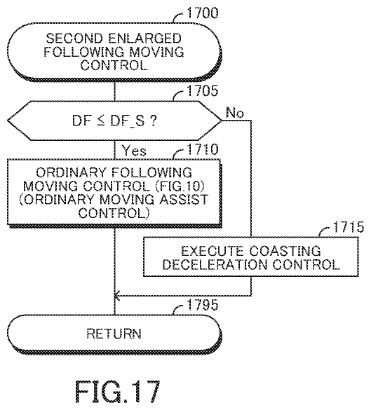

When the CPU determines “Yes” at the step 1530 of the routine shown in FIG. 15, the CPU proceeds with the process to a step 1535 to execute the second enlarged following moving control by executing a routine shown in FIG. 17. Thus, when the CPU proceeds with the process to the step 1535, the CPU starts to execute a process from a step 1700 of the routine shown in FIG. 17 and proceeds with the process to a step 1705 to determine whether the forward short distance condition is satisfied. In this embodiment, the CPU determines whether the forward short distance condition is satisfied by determining whether the forward inter-vehicle distance DF is equal to or smaller than the forward short distance determination value DF_S.

When the CPU determines “Yes” at the step 1705, the CPU proceeds with the process to a step 1710 to execute the ordinary following moving control by executing a routine shown in FIG. 10. After the CPU executes the routine shown in FIG. 10, the CPU proceeds with the process to the step 995 via a step 1795 and the step 1595 of the routine shown in FIG. 15 to terminate executing this routine once.

On the other hand, when the CPU determines “No” at the step 1705 of the routine shown in FIG. 17, the CPU proceeds with the process to a step 1715 to execute the coasting deceleration control. Next, the CPU proceeds with the process to the step 995 via the step 1795 and the step 1595 of the routine shown in FIG. 15 to terminate executing this routine once.

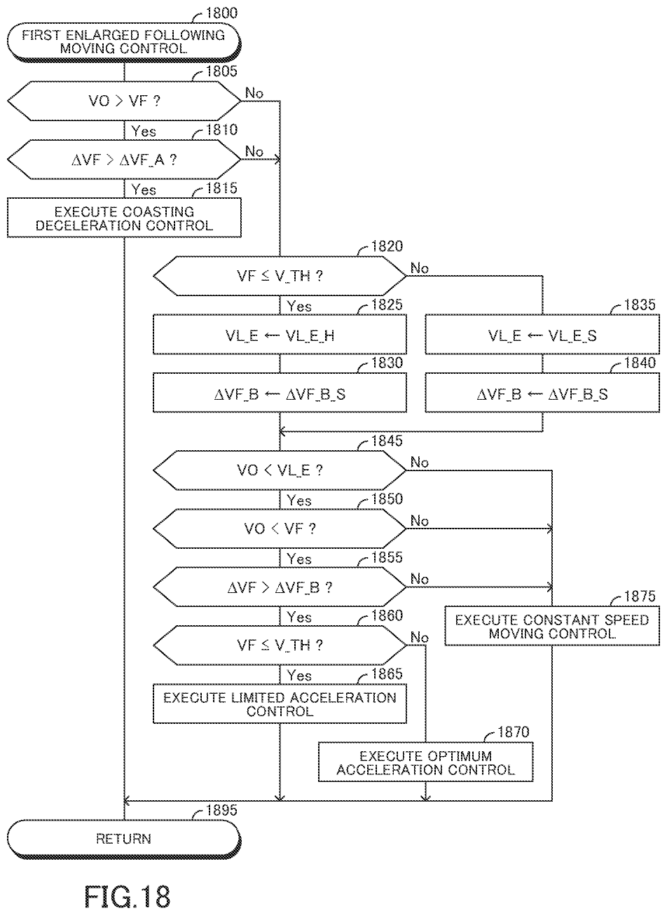

Further, when the CPU determines “No” at the step 1530 of the routine shown in FIG. 15, the CPU proceeds with the process to a step 1540 to execute the first enlarged following moving control by executing a routine shown in FIG. 18. Thus, when the CPU proceeds with the process to the step 1540, the CPU starts to execute a process from a step 1800 of the routine shown in FIG. 18 and proceeds with the process to a step 1805 to determine whether one of satisfaction conditions for satisfying the forward approaching condition is satisfied. In this embodiment, the CPU determines whether one of the satisfaction conditions for satisfying the forward approaching condition is satisfied by determining whether the own vehicle moving speed VO is greater than the preceding vehicle moving speed VF.

When the CPU determines “Yes” at the step 1805, the CPU proceeds with the process to a step 1810 to determine whether one of the satisfaction conditions for satisfying the forward approaching condition is satisfied. In this embodiment, the CPU determines whether one of the satisfaction conditions for satisfying the forward approaching condition is satisfied by determining whether the preceding vehicle moving speed difference ΔVF (i.e., a difference between the own vehicle moving speed VO and the preceding vehicle moving speed VF) is greater than the forward approaching vehicle moving speed difference ΔVF_A.

When the CPU determines “Yes” at the step 1810, the CPU proceeds with the process to a step 1815 to execute the coasting deceleration control. Next, the CPU proceeds with the process to the step 995 of the routine shown in FIG. 9 via a step 1895 and the step 1595 of the routine shown in FIG. 15 to terminate executing this routine once.

On the other hand, when the CPU determines “No” at the step 1805 or the step 1810, the CPU proceeds with the process to a step 1820 to determine whether the following acceleration determination change condition is satisfied. In this embodiment, the CPU determines whether the following acceleration determination change condition is satisfied by determining whether the preceding vehicle moving speed VF is equal to or smaller than the predetermined vehicle moving speed V_TH.

When the CPU determines “Yes” at the step 1820, the CPU proceeds with the process to a step 1825 to set the enlarged vehicle moving speed lower limit VL_E to the increased lower limit VL_E_H. Next, the CPU proceeds with the process to a step 1830 to set the forward separation vehicle moving speed difference ΔVF_B to the decreased forward separation vehicle moving speed difference ΔVF_B_L. Next, the CPU proceeds with the process to a step 1845.

When the CPU determines “No” at the step 1820, the CPU proceeds with the process to a step 1835 to set the enlarged vehicle moving speed lower limit VL_E to the standard lower limit VL_E_S. Next, the CPU proceeds with the process to a step 1840 to set the forward separation vehicle moving speed difference ΔVF_B to the standard forward separation vehicle moving speed difference ΔVF_B_S. Next, the CPU proceeds with the process to the step 1845.

When the CPU proceeds with the process to the step 1845, the CPU determines whether one of the satisfaction conditions for satisfying the forward separation condition is satisfied. In this embodiment, the CPU determines whether one of the satisfaction conditions for satisfying the forward separation condition is satisfied by determining whether the own vehicle moving speed VO is smaller than the enlarged vehicle moving speed lower limit VL_E.

When the CPU determines “Yes” at the step 1845, the CPU proceeds with the process to a step 1850 to determine whether one of the satisfaction conditions for satisfying the forward separation condition is satisfied. In this embodiment, the CPU determines whether one of the satisfaction conditions for satisfying the forward separation condition is satisfied by determining whether the own vehicle moving speed VO is smaller than the preceding vehicle moving speed VF.

When the CPU determines “Yes” at the step 1850, the CPU proceeds with the process to a step 1855 to determine whether one of the satisfaction conditions for satisfying the forward separation condition is satisfied. In this embodiment, the CPU determines whether one of the satisfaction conditions for satisfying the forward separation condition is satisfied by determining whether the preceding vehicle moving speed difference ΔVF (i.e., the difference between the own vehicle moving speed VO and the preceding vehicle moving speed VF) is greater than the forward separation vehicle moving speed difference ΔVF_B.

When the CPU determines “Yes” at the step 1855, the CPU proceeds with the process to a step 1860 to determine whether the following acceleration determination change condition is satisfied. In this embodiment, the CPU determines whether the following acceleration determination change condition is satisfied by determining whether the preceding vehicle moving speed VF is equal to or smaller than the predetermined vehicle moving speed V_TH.

When the CPU determines “Yes” at the step 1860, the CPU proceeds with the process to a step 1865 to execute the limited acceleration control. Next, the CPU proceeds with the process to the step 995 of the routine shown in FIG. 9 via the step 1895 and the step 1595 of the routine shown in FIG. 15 to terminate executing this routine once.

On the other hand, when the CPU determines “No” at the step 1860, the CPU proceeds with the process to a step 1870 to execute the optimum acceleration control. Next, the CPU proceeds with the process to the step 995 of the routine shown in FIG. 9 via the step 1895 and the step 1595 of the routine shown in FIG. 15 to terminate executing this routine once.

Further, when the CPU determines “No” at the step 1845, the step 1850, or the step 1855, the CPU proceeds with the process to a step 1875 to execute the steady moving control. Next, the CPU proceeds with the process to the step 995 of the routine shown in FIG. 9 via the step 1895 and the step 1595 of the routine shown in FIG. 15 to terminate executing this routine once.

Further, when the CPU determines “No” at the step 910 of the routine shown in

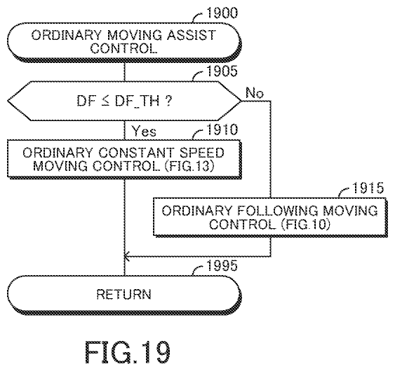

FIG. 9, the CPU proceeds with the process to a step 940 to execute the ordinary moving assist control by executing a routine shown in FIG. 19. Thus, when the CPU proceeds with the process to the step 940, the CPU starts to execute a process from a step 1900 of the routine shown in FIG. 19 and proceeds with the process to a step 1905 to determine whether the preceding vehicle condition is satisfied. In this embodiment, the CPU determines whether the preceding vehicle condition is satisfied by determining whether the forward inter-vehicle distance DF is equal to or smaller than the preceding vehicle determination distance DF_TH.

When the CPU determines “Yes” at the step 1905, the CPU proceeds with the process to a step 1910 to execute the ordinary constant speed moving control by executing the routine shown in FIG. 13. After the CPU executes the routine shown in FIG. 13, the CPU proceeds with the process to the step 995 of the routine shown in FIG. 9 via a step 1995 to terminate executing this routine once.

On the other hand, when the CPU determines “No” at the step 1905, the CPU proceeds with the process to a step 1915 to execute the ordinary following moving control by executing the routine shown in FIG. 10. After the CPU executes the routine shown in FIG. 10, the CPU proceeds with the process to the step 995 of the routine shown in FIG. 9 via the step 1995 to terminate executing this routine once.

Further, when the CPU determines “No” at the step 905 of the routine shown in FIG. 9, the CPU proceeds with the process directly to the step 995 to terminate executing this routine once.

The specific operations of the vehicle driving assist apparatus 10 have been described.

It should be noted that the invention is not limited to the aforementioned embodiments, and various modifications can be employed within the scope of the invention.

What is claimed is:

1. A vehicle driving assist apparatus, comprising:
a driving apparatus which outputs a driving force to be applied to an own vehicle; and
an electronic control unit which executes a constant speed moving control to accelerate and decelerate the own vehicle so as to maintain a vehicle moving speed of the own vehicle at a set vehicle moving speed by controlling operations of the driving apparatus,
the electronic control unit being configured to execute an enlarged constant speed moving control as the constant speed moving control to:
set an enlarged vehicle moving speed control range which corresponds to a vehicle moving speed range including the set vehicle moving speed; and
maintain the vehicle moving speed of the own vehicle at the set vehicle moving speed by (i) starting to decelerate the own vehicle when the vehicle moving speed of the own vehicle becomes greater than an upper limit of the enlarged vehicle moving speed control range and (ii) starting to accelerate the own vehicle when the vehicle moving speed of the own vehicle becomes smaller than a lower limit of the enlarged vehicle moving speed control range,
wherein while the enlarged constant speed moving control is executed, the electronic control unit is configured to set the lower limit of the enlarged vehicle moving speed control range such that a first lower limit difference is smaller than a second lower limit difference,
the first lower limit difference is a difference between the lower limit of the enlarged vehicle moving speed control range and the set vehicle moving speed while (i) the enlarged constant speed moving control is executed, and (ii) a constant speed acceleration determination change condition is satisfied,
the second lower limit difference is the difference between the lower limit of the enlarged vehicle moving speed control range and the set vehicle moving speed while (i) the enlarged constant speed moving control is executed, and (ii) the constant speed acceleration determination change condition is not satisfied, and
the constant speed acceleration determination change condition is a condition that the set vehicle moving speed is equal to or smaller than a predetermined vehicle moving speed, or
wherein while the enlarged constant speed moving control is executed, the electronic control unit is configured to:
when the own vehicle is required to be accelerated while the constant speed acceleration determination change condition is not satisfied,
accelerate the own vehicle by operating the driving apparatus with an optimum energy efficient; and
when the own vehicle is required to be accelerated while the constant speed acceleration determination change condition is satisfied,
accelerate the own vehicle by operating the driving apparatus such that the driving force output from the driving apparatus is smaller than the driving force output from the driving apparatus operating with the optimum energy efficient.

2. The vehicle driving assist apparatus as set forth in claim 1,
wherein the electronic control unit is configured to execute an ordinary constant speed moving control as the constant speed moving control to:
set an ordinary vehicle moving speed control range which corresponds to a vehicle moving speed range which includes the set vehicle moving speed and is narrower than the enlarged vehicle moving speed control range; and
maintain the vehicle moving speed of the own vehicle at the set vehicle moving speed by (i) starting to decelerate the own vehicle when the vehicle moving speed of the own vehicle becomes greater than an upper limit of the ordinary vehicle moving speed control range and (ii) starting to accelerate the own vehicle when the vehicle moving speed of the own vehicle becomes smaller than a lower limit of the ordinary vehicle moving speed control range.

3. The vehicle driving assist apparatus as set forth in claim 1, wherein while (i) the enlarged constant speed moving control is executed, and (ii) the constant speed acceleration determination change condition is satisfied, the electronic control unit is configured to set the lower limit of the enlarged vehicle moving speed control range such that the first lower limit difference is smaller than the second lower limit difference by narrowing the enlarged vehicle moving speed control range.

4. The vehicle driving assist apparatus as set forth in claim 1, wherein the electronic control unit is configured to set the enlarged vehicle moving speed control range such that the difference between the lower value of the enlarged vehicle moving speed control range and the set vehicle moving speed is greater than a difference between an upper limit value of the enlarged vehicle moving speed control range and the set vehicle moving speed.

5. The vehicle driving assist apparatus as set forth in claim 1, wherein the constant speed acceleration determination change condition includes a condition that a gradient of a road on which the own vehicle moves is equal to or smaller than a predetermined upward slope gradient.

6. The vehicle driving assist apparatus as set forth in claim 1, wherein the electronic control unit is configured to determine that the constant speed acceleration determination change condition is not satisfied when a gradient of a road on which the own vehicle moves is greater than a predetermined upward slope gradient while (i) the enlarged constant speed moving control is executed, and (ii) the set vehicle moving speed is equal to or smaller than the predetermined vehicle moving speed.

7. The vehicle driving assist apparatus as set forth in claim 1,
wherein when there is a preceding vehicle, in place of the constant speed moving control, the electronic control unit is configured to:
execute an enlarged following moving control to:
start to accelerate the own vehicle when a preceding vehicle separation degree becomes greater than a predetermined preceding vehicle separation degree, which preceding vehicle separation degree being a degree that the own vehicle is separating from the preceding vehicle; and
start to decelerate the own vehicle when a preceding vehicle approaching degree becomes greater than a predetermined preceding vehicle approaching degree, which preceding vehicle approaching degree being a degree that the own vehicle is approaching the preceding vehicle; and
set the predetermined preceding vehicle separation degree such that the predetermined preceding vehicle separation degree which is set while (i) the enlarged following moving control is executed, and (ii) a following acceleration determination change condition is satisfied, is smaller than the predetermined preceding vehicle separation degree which is set while (i) the enlarged following moving control is executed, and (ii) the following acceleration determination change condition is not satisfied,
the following acceleration determination change condition is a condition that a vehicle moving speed of the preceding vehicle is equal to or smaller than the predetermined vehicle moving speed, or
wherein the electronic control unit is configured to:
when the own vehicle is required to be accelerated while (i) the enlarged following moving control is executed, and (ii) the following acceleration determination change condition is not satisfied,
accelerate the own vehicle by operating the driving apparatus with an optimum energy efficient; and
when the own vehicle is required to be accelerated while (i) the enlarged following moving control is executed, and (ii) the following acceleration determination change condition is satisfied,
accelerate the own vehicle by operating the driving apparatus so as to output the driving force which is smaller than the driving force output from the driving apparatus operating with the optimum energy efficient.

8. A vehicle driving assist method of executing a constant speed moving control to accelerate and decelerate an own vehicle so as to maintain a vehicle moving speed of the own vehicle at a set vehicle moving speed by controlling operations of a driving apparatus for outputting a driving force to be applied to the own vehicle,
wherein the vehicle driving assist method comprises executing an enlarged constant speed moving control as the constant speed moving control to:
set an enlarged vehicle moving speed control range which corresponds to a vehicle moving speed range including the set vehicle moving speed; and
maintain the vehicle moving speed of the own vehicle at the set vehicle moving speed by (i) starting to decelerate the own vehicle when the vehicle moving speed of the own vehicle becomes greater than an upper limit of the enlarged vehicle moving speed control range and (ii) starting to accelerate the own vehicle when the vehicle moving speed of the own vehicle becomes smaller than a lower limit of the enlarged vehicle moving speed control range,
wherein while the enlarged constant speed moving control is executed, the vehicle driving assist method comprises setting the lower limit of the enlarged vehicle moving speed control range such that a first lower limit difference is smaller than a second lower limit difference while the enlarged constant speed moving control is executed,
the first lower limit difference is a difference between the lower limit of the enlarged vehicle moving speed control range and the set vehicle moving speed while (i) the enlarged constant speed moving control is executed, and (ii) a constant speed acceleration determination change condition is satisfied,
the second lower limit difference is the difference between the lower limit of the enlarged vehicle moving speed control range and the set vehicle moving speed while (i) the enlarged constant speed moving control is executed, and (ii) the constant speed acceleration determination change condition is not satisfied, and
the constant speed acceleration determination change condition is a condition that the set vehicle moving speed is equal to or smaller than a predetermined vehicle moving speed, or
wherein while the enlarged constant speed moving control is executed, the vehicle driving assist method comprises:
when the own vehicle is required to be accelerated while the constant speed acceleration determination change condition is not satisfied,
accelerating the own vehicle by operating the driving apparatus with an optimum energy efficient; and
when the own vehicle is required to be accelerated while the constant speed acceleration determination change condition is satisfied,
accelerating the own vehicle by operating the driving apparatus such that the driving force output from the driving apparatus is smaller than the driving force output from the driving apparatus operating with the optimum energy efficient.

9. A vehicle driving assist program of executing a constant speed moving control to accelerate and decelerate an own vehicle so as to maintain a vehicle moving speed of the own vehicle at a set vehicle moving speed by controlling operations of a driving apparatus for outputting a driving force to be applied to the own vehicle,
wherein the vehicle driving assist program comprises executing an enlarged constant speed moving control as the constant speed moving control to:
set an enlarged vehicle moving speed control range which corresponds to a vehicle moving speed range including the set vehicle moving speed; and
maintain the vehicle moving speed of the own vehicle at the set vehicle moving speed by (i) starting to decelerate the own vehicle when the vehicle moving speed of the own vehicle becomes greater than an upper limit of the enlarged vehicle moving speed control range and (ii) starting to accelerate the own vehicle when the vehicle moving speed of the own vehicle becomes smaller than a lower limit of the enlarged vehicle moving speed control range,
wherein while the enlarged constant speed moving control is executed, the vehicle driving assist program comprises setting the lower limit of the enlarged vehicle moving speed control range such that a first lower limit difference is smaller than a second lower limit difference while the enlarged constant speed moving control is executed,
the first lower limit difference is a difference between the lower limit of the enlarged vehicle moving speed control range and the set vehicle moving speed while (i) the enlarged constant speed moving control is executed, and (ii) a constant speed acceleration determination change condition is satisfied,
the second lower limit difference is the difference between the lower limit of the enlarged vehicle moving speed control range and the set vehicle moving speed while (i) the enlarged constant speed moving control is executed, and (ii) the constant speed acceleration determination change condition is not satisfied, and
the constant speed acceleration determination change condition is a condition that the set vehicle moving speed is equal to or smaller than a predetermined vehicle moving speed, or
wherein while the enlarged constant speed moving control is executed, the vehicle driving assist program comprises:
when the own vehicle is required to be accelerated while the constant speed acceleration determination change condition is not satisfied,
accelerating the own vehicle by operating the driving apparatus with an optimum energy efficient; and
when the own vehicle is required to be accelerated while the constant speed acceleration determination change condition is satisfied,
accelerating the own vehicle by operating the driving apparatus such that the driving force output from the driving apparatus is smaller than the driving force output from the driving apparatus operating with the optimum energy efficient.
